(19) United States
(12) Patent Application Publication
(10) Pub. No.: US 2008/0300702 A1
(43) Pub. Date: Dec. 4, 2008

(54) MUSIC SIMILARITY SYSTEMS AND METHODS USING DESCRIPTORS

(75) Inventors: Emilia Gomez, Barcelona (ES); Perfecto Herrera, Barcelona (ES); Pedro Cano Vila, Barcelona (ES); Jordi Janer, Vilafranca del Penedes (ES); Joan Serra, Barcelona (ES); Jordi Bonada, Barcelona (ES); Shadi Walid El-Hajj, Barcelona (ES); Thomas Etienne Aussenac, Barcelona (ES); Gunnar Nils Holmberg, Barcelona (ES)

Correspondence Address: FAEGRE & BENSON LLP;PATENT DOCKETING, 2200 WELLS FARGO CENTER, 90 SOUTH SEVENTH STREET, MINNEAPOLIS, MN, 55402-3901, US

(73) Assignee: UNIVERSITAT POMPEU FABRA, Barcelona (ES)

(21) Appl. No.: 12/128,917

(22) Filed: May 29, 2008

Related U.S. Application Data
(60) Provisional application No. 60/940,537, filed on May 29, 2007.
(60) Provisional application No. 60/946,860, filed on Jun. 28, 2007.
(60) Provisional application No. 60/970,109, filed on Sep. 5, 2007.
(60) Provisional application No. 60/988,714, filed on Nov. 16, 2007.

(51) Int. Cl. G06F 17/00

(52) U.S. Cl. 700/94

(57) ABSTRACT

Systems and methods for determining similarity between two or more audio pieces are disclosed. An illustrative method for determining musical similarities includes extracting one or more descriptors from each audio piece, generating a vector for each of the audio pieces, extracting one or more audio features from each of the audio pieces, calculating values for each audio feature, calculating a distance between a vector containing the normalized values and the vectors containing the audio pieces, and outputting a response to a user or process indicating the similarity between the audio pieces. The descriptors can be used in performing content-based audio classification and for determining similarities between music. The descriptors that can be extracted from each audio piece can include tonal descriptors, dissonance descriptors, rhythm descriptors, and spatial descriptors.

### PRIORITY CLAIM

This application claims benefit under 35 U.S.C. §119 to U.S. Provisional Application No. 60/940,537, filed on May 29, 2007, entitled “TONAL DESCRIPTORS OF MUSIC AUDIO SIGNALS;” U.S. Provisional Application No. 60/946,860, filed on Jun. 28, 2007, entitled “MUSIC SIMILARITY METHOD BASED ON INSTANTANEOUS SEQUENCES OF TONAL DESCRIPTORS;” U.S. Provisional Application No. 60/970,109, filed on Sep. 5, 2007, entitled “PANORAMA FEATURES FOR MULTICHANNEL AUDIO MIXTURES CLASSIFICATION;” and U.S. Provisional Application No. 60/988,714, filed on Nov. 16, 2007, entitled “MUSIC SIMILARITY SYSTEMS AND METHODS USING DESCRIPTORS;” all of which are incorporated herein by reference in their entirety.

### TECHNICAL FIELD

The present invention relates generally to the field of audio classification systems and techniques for determining similarities between audio pieces. More specifically, the present invention relates to systems and methods for providing a music similarity framework that can be utilized to extract features or sets of features from an audio piece based on descriptors, and for performing content-based audio classification.

### BACKGROUND

In the past few years, an increasing amount of audio material has been made accessible to home users through networks and mass storage. Many portable audio devices, for example, are now capable of downloading and storing several thousands of songs. The audio files contained on these devices are often organized and searchable by means of annotation information such as the name of the artist, the name of the song, and the name of the album or musical score. Due to the tremendous growth of music-related data available, however, there is an increasing need for audio classification systems that allow users to interact with such collections in an easier and more efficient way. As a result, a number of different audio classification systems have been developed to facilitate retrieval and classification of audio files. Content-based description of audio files, for example, has become increasingly relevant in the context of Music Information Retrieval (MIR) in order to provide users with a means to automatically extract desired information from audio files.

Audio classification systems typically utilize a front-end system that extracts acoustic features from an audio signal, and machine-learning or statistical techniques for classifying an audio piece according to a given criterion such as genre, tempo, or key. Some content-based audio classification systems are based on extracting spectral features within the audio signal, often on a frame-by-frame basis. In the classification of audio files containing multi-channel audio, for example, spectral features may be extracted from the audio file using statistical techniques that employ Short-Time Fourier Transforms (SFTs) and Mel-Frequency Cepstrum Coefficients (MFCCs). Statistical measures have also been employed to extract spectral features from an entire audio piece such as a song or musical score.

In some cases, the audio classification system may be tasked to find similarities between multiple audio pieces. When dealing with large music collections, for example, it is not uncommon to find different cover versions of the same song. One situation in which a song or musical piece may have different versions available includes the digital remastering of an original master version. Other cases in which different versions of the same song or musical piece may be available include the recording of a live track from a live performance, a karaoke version of the song translated to a different language, or an acoustic track or remix in which one or more instruments have been changed in timbre, tempo, pitch, etc. to create a new song. In some situations, an artist may perform a cover version of a particular song that may have differing levels of musical similarity (e.g., style, harmonization, instrumentation, tempo, structure, etc.) between the original and cover version. The degree of disparity between these different aspects often establishes a vague boundary between what is considered a cover version of the song or an entirely different version of the song.

The evaluation of similarity measures in music is often a difficult task, particularly in view of the large quantity of music currently available and the different musical, cultural, and personal aspects associated with music. This process is often exacerbated in certain genres of music where the score is not available, as is the case in most popular music. Another factor that becomes relevant when analyzing large amounts of data is the computational cost of the algorithms used in detecting music similarities. In general, the algorithm performing the similarity analysis should be capable of quickly analyzing large amounts of data, and should be robust enough to handle real situations where vast differences in musical styles are commonplace.

A number of different approaches for computing music similarity from audio pieces have been developed. Many of these approaches are based on timbre similarity, which propose the use of similarity measures related to low-level, timbre features in the audio piece, mainly MFCCs and fluctuation patterns representing loudness fluctuations in different frequency bands. Other approaches have focused on the study of rhythmic similarity and tempo.

### SUMMARY

The present invention pertains to systems and methods for providing a music similarity framework that can be utilized to extract features or sets of features from an audio piece based on descriptors, and for performing content-based audio classification. An illustrative method for determining similarity between two or more audio pieces may include the steps of extracting one or more descriptors from each of the audio pieces, generating a vector for each of the audio pieces, extracting one or more audio features from each of the audio pieces, calculating values for each audio feature, normalizing the values for each audio feature, calculating a distance between a vector containing the normalized values and the vectors containing the audio pieces, and outputting a result to a user or process. The descriptors extracted from the audio pieces can include dissonance descriptors, tonal descriptors, rhythm descriptors, and/or spatial descriptors. An illustrative tonal descriptor, for example, is a Harmonic Pitch Class Profile (HPCP) vector, which in some embodiments can be used to provide key estimation and tracking, chord estimation, and/or to perform a music similarity analysis between audio pieces.

An illustrative music processing system in accordance with an embodiment of the present invention can include an input device for receiving an audio signal containing an audio piece, a tonality analysis module configured to extract tonal features from the audio signal, a data storing device adapted to store the extracted tonal features, a tonality comparison device configured to compare the extracted tonal features to tonal features from one or more reference audio pieces stored in memory, and an interface for providing a list of audio pieces to a user. The music processing system may utilize one or more descriptors to classify the audio piece and/or to perform a music similarity analysis on the audio piece. In some embodiments, for example, the music processing system can be tasked to determine whether the audio piece is a cover version of at least one of the reference audio pieces.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 is a block diagram of a music processing system in accordance with an illustrative embodiment;

FIG. 2 is a block diagram showing an illustrative method of computing a Harmonic Pitch Class Profile (HPCP) vector;

FIG. 3 is a block diagram showing an illustrative implementation of computing an HPCP vector using band preset and frequency filtering;

FIG. 4 is a block diagram showing an illustrative method for providing linear mapping to an amplitude normalized HPCP vector;

FIG. 5 is a block diagram of an illustrative method of obtaining a tonality estimate using an HPCP vector;

FIG. 6 is a block diagram of an illustrative method of determining an equal tempered deviation descriptor;

FIG. 7 is a block diagram of an illustrative music similarity system for finding similarities between songs;

FIGS. 8-10 is a flow chart showing an illustrative method for detecting cover songs using the music similarity system of FIG. 7;

FIG. 11 is a block diagram showing an illustrative input and output of the description extractors module of FIG. 7;

FIG. 12 is a block diagram showing the refinement of the HPCP matrix using the HPCP post processing module of FIG. 7;

FIG. 13 is a block diagram showing the calculation of a global HPCP using the HPCP averaging module of FIG. 7;

FIG. 14 is a block diagram showing the calculation of a transposition index using the transposition module of FIG. 7;

FIG. 15 is a block diagram showing the calculation of a similarity matrix using the similarity matrix creation module of FIG. 7;

FIG. 16 is a block diagram showing the calculation of a local alignment matrix using the dynamic programming local alignment module of FIG. 7;

FIG. 17 is a block diagram showing the calculation of song alignments and song distance using the alignment analysis module and score post-processing module of FIG. 7;

FIG. 18 is a flow chart showing an illustrative backtracking algorithm that can be used to determine a similarity path;

FIG. 19 is an illustrative dendrogram showing the distances between a set of known songs;

FIG. 20 is a flow chart showing an illustrative method of determining whether an audio piece belongs to a western or non-western musical genre;

FIG. 21 is a flow chart showing an illustrative method of determining the dissonance of an audio piece;

FIG. 22 is a graph showing the relationship between critical bandwidth or bark values and dissonance/consonance;

FIG. 23 is a flow chart showing an illustrative method of determining the dissonance between chords in an audio piece;

FIG. 24 is a flow chart showing an illustrative method of computing the spectral complexity of an audio piece;

FIG. 25 is a flow chart showing an illustrative method of determining the onset rate of an audio piece;

FIG. 26 is a flow chart showing an illustrative method of determining the beats-per-minute (BPM) of an audio piece;

FIG. 27 is a flow chart showing an illustrative method for calculating the beats loudness and/or bass beats loudness of an audio piece;

FIG. 28 is a flow chart showing an illustrative method of computing a rhythmic intensity descriptor;

FIG. 29 is a block diagram of an illustrative audio classification system for combining spectral features within spatial features within an audio piece;

FIG. 30 is a flow chart showing an illustrative method of extracting panning coefficients from the audio piece using the audio classification system of FIG. 29;

FIG. 31 is a graph showing a warping function applied to the azimuth angle of the histogram;

FIG. 32 is a graph showing a representation of the extracted panning coefficients for a Jazz recording;

FIG. 33 shows a representation of the extracted panning coefficients for a Pop-Rock recording; and

FIG. 34 is a flow chart showing an illustrative method for determining musical similarity between audio pieces.

While the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

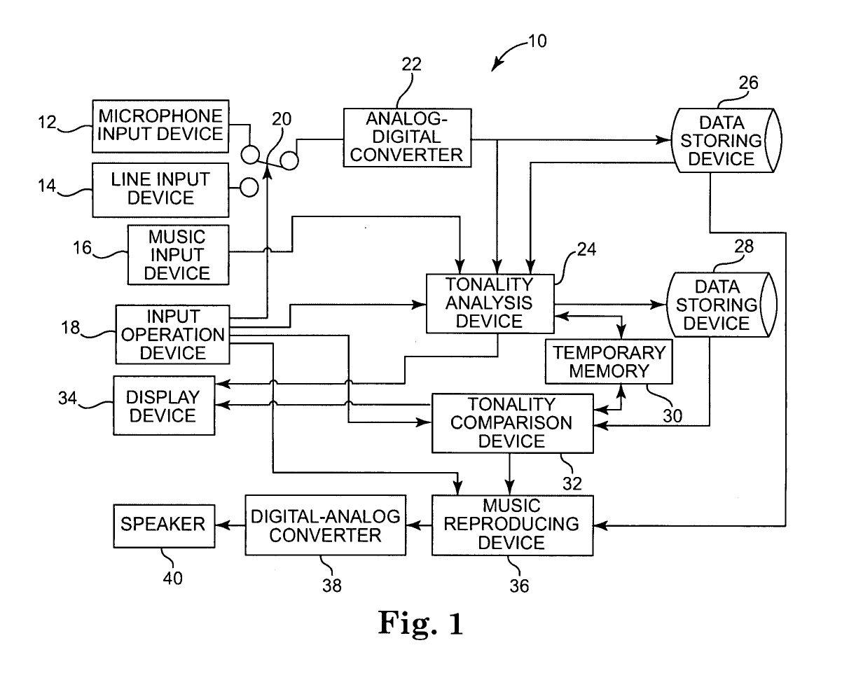

Referring now to FIG. 1, a block diagram of a music processing system 10 in accordance with an illustrative embodiment of the present invention will now be described. As shown in FIG. 1, the music processing system 10 includes a microphone input device 12, a line input device 14, a music input device 16, an input operation device 18, an input selector switch 20, an analog-to-digital (A/D) converter 22, a tonality analysis device 24, data storing devices 26,28, a temporary memory 30, a tonality comparison device 32, a display device 34, a music reproducing device 36, a digital-to-analog (D/A) converter 38, and a speaker 40.

The microphone input device 12 can collect a music audio signal with a microphone and output an analog audio signal representing the collected music audio signal. The line input device 14 can be connected to a disc player, tape recorder, or other such device so that an analog audio signal containing an audio piece can be input. The music input device 16 may be, for example, an MP3 player or other digital audio player (DAP) connected to the tonality analysis device 24 and the data storing device 28 to reproduce a digitized audio signal, such as a PCM signal. The input operation device 18 can be a device for a user or process to input data or commands to the system 10. The output of the input operation device 18 is connected to the input selector switch 20, the tonality analysis device 24, the tonality comparison device 32, and the music reproducing device 36.

The input selector switch 20 can be used to selectively supply one of the output signals from the microphone input device 12 and the line input device 14 to the A/D converter 22. In some embodiments, the input selector switch 20 may operate in response to a command from the input operation device 18.

The A/D converter 22 is connected to the tonality analysis device 24 and the data storing device 26, and is configured to digitize an analog audio signal and supply the digitized audio signal to the data storing device 28 as music data. The data storing device 26 stores the music data supplied from the A/D converter 22 and the music input device 16. The data storing device 26 may also provide access to digitized audio stored in a computer hard drive or other suitable storage device.

The tonality analysis device 24 can be configured to extract tonal features from the supplied music data by executing a tonality analysis operation described further herein. The tonal features obtained from the music data are stored in the data storing device 28. A temporary memory 30 is used by the tonality analysis device 24 to store intermediate information. The display device 34 displays a visualization of the tonal features extracted by the tonality analysis device 24.

The tonality comparison device 32 can be tasked to compare tonal features within a search query to the tonal features stored in the data storing device 28. A set of tonal features with high similarities to the search query may be detected by the tonality comparison device 32. In a search query to detect a cover version of a particular song, for example, a set of tonal features with high similarities may be detected within the song via the tonality comparison device 32, indicating the likelihood that the song is a cover version. The display device 34 may then display a result of the comparison as a list of audio pieces.

The music reproducing device 36 reads out the data file of the audio pieces detected as showing the highest similarity by the tonality comparison device 32 from the data storing device 26, reproduces the data and outputs the data as a digital audio signal. The D/A converter 38 converts the digital audio signal reproduced by the music reproducing device 36 into an analog audio signal, which may then be delivered to a user via the speaker 40.

The tonality analysis device 24, the tonality comparison device 26, and the music reproducing device 36 may each operate in response to a command from the input operation device 18. In certain embodiments, for example, the input operation device 18 may comprise a graphical user interface (GUI), keyboard, touchpad, or other suitable interface that can be used to select the particular input device 12,14,16 to receive an audio signal, to select one or more search queries for analysis, or to perform other desired tasks.

The music processing system 10 is configured to automatically extract semantic descriptors in order to analyze the content of the music. As discussed further herein, exemplary descriptors that can be extracted include, but are not limited to, tonal descriptors, dissonance or consonance descriptors, rhythm descriptors, and spatial descriptors. Exemplary tonal descriptors can include, for example, a Harmonic Pitch Class Profile (HPCP) descriptor, a chord detection descriptor, a key detection descriptor, a local tonality detection descriptor, a cover song detection descriptor, and a western/non-western music detection descriptor. Exemplary dissonance or consonance descriptors can include a dissonance descriptor, a dissonance of chords descriptor, and a spectral complexity descriptor. Exemplary rhythm descriptors can include an onset rate descriptor, a beats per minute descriptor, a beats loudness descriptor, and a bass beats loudness descriptor. An example spatial descriptor can include a panning descriptor.

The descriptors used to extract musical content from an audio piece can be generated as derivations and combinations of lower-level descriptors, and as generalizations induced from manually annotated databases by the application of machine-learning techniques. Some of the musical descriptors can be classified as instantaneous descriptors, which relate to an analysis frame representing a minimum temporal unit of the audio piece. An exemplary instantaneous descriptor may be the fundamental frequency, pitch class distribution, or chord of an analysis frame. Other musical descriptors are related to a certain segment of the musical piece, or to global descriptors relating to the entire musical piece (e.g., global pitch class distribution or key). An example global descriptor may be, for example, a phrase or chorus of a musical piece.

### Tonal Descriptors

The music processing system 10 may utilize tonal descriptors to automatically extract a set of tonal features from an audio piece. In certain embodiments, for example, the tonal descriptors can be used to locate cover versions of the same song or to detect the key of a particular audio piece.

Harmonic Pitch Class Profile (HPCP)

The music processing system 10 can be configured to compute a Harmonic Pitch Class Profile (HPCP) vector of each audio piece. The HPCP vector may represent a low-level tonal descriptor that can be used to provide key estimation and tracking, chord estimation, and to perform music similarity between audio pieces. In certain embodiments, for example, a correlation between HPCP vectors can be used to identify versions of the same song by computing similarity measures for each song.

In some embodiments, a set of features representative of the pitch class distribution of the music can be extracted. The pitch-class distribution of the music can be related, either directly or indirectly, to the chords and the tonality of a piece, and is general to all types of music. Chords can be recognized from the pitch-dass distribution without precisely detecting which notes are played in the music. Tonality can also be estimated from the pitch-class distribution without a previous chord-estimation procedure. These features can be also used to determine music similarity between pieces.

The pitch class descriptors may fulfill one or more requirements in order to reliably extract information from the audio signal. The pitch class descriptors may take into consideration, for example, the pitch class distribution in both monophonic and polyphonic audio signals, the presence of harmonic frequencies within the audio signal, are robust to ambient noise (e.g., noise occurring during live recordings, percussive sounds, etc.), are independent of timbre and the types of played instruments within the audio signal such that the same piece played with different instruments has the same tonal description, are independent of loudness and dynamics within the piece, and are independent of tuning such that the reference frequency within the piece can be different from the standard A reference frequency (i.e. 440 Hz). The pitch class descriptors can also exhibit other desired features.

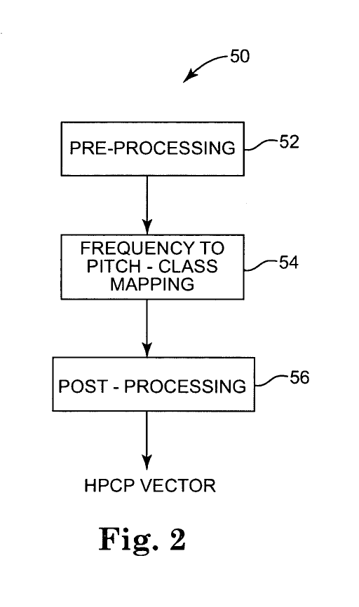

An illustrative method 50 of computing a Harmonic Pitch Class Profile (HPCP) vector of an audio piece will now be described with respect to FIG. 2. As shown in FIG. 2, an HPCP vector can be computed over three main stages, including a pre-processing stage (block 52), a frequency to pitch-class mapping stage (block 54), and a post-processing stage (block 56).

The pre-processing stage (block 52) can include the step of performing a frequency quantization in order to obtain a spectral analysis on the audio piece. In certain embodiments, for example, a spectral analysis using a Discrete Fourier Transform is performed. In some embodiments, the frequency quantization can be computed with long frames of 4096 samples at a 44.1 kHz sampling rate, a hop size of 2048, and windowing.

The spectrum obtained via the spectral analysis can be normalized according to its spectral envelope in order to convert it to a flat spectrum. Using this timbre normalization, notes on high octaves contribute equally to the final HPCP vector than those notes on low pitch range so that the results are not influenced by different equalization procedures.

A peak detection step is then performed on the spectra wherein the local maxima of the spectra (representing the harmonic part of the spectrum) are extracted. A global tuning frequency value is then determined from the spectral peaks. In certain embodiments, for example, a global tuning frequency value may be determined by computing the deviation of frequency values with respect to the A440 Hz reference frequency mapped to a semitone, and then computing a histogram of values, as understood from the following equations (1) to (3) below. The tuning frequency, which is assumed to be constant for a given musical piece, can then be defined by the maximum value of the histogram, as further discussed herein.

$$\begin{matrix}{β}_{i} = 12 \cdot {log}_{2} ( \frac{{f}_{i}}{440} ) & ( 1 ) \\ {d}_{i} = {β}_{i} - round ( {β}_{i} ) & ( 2 ) \\ hist ( n ) = {\sum }_{i , {d}_{i} + 0.5 ∈ [ ( n - 1 ) r , nr ]} {a}_{i} & ( 3 )\end{matrix}$$

A value can then be computed for each analysis frame in a given segment of the piece, and a global value computed by building a histogram of frame values and selecting the value corresponding to the maximum of the histogram.

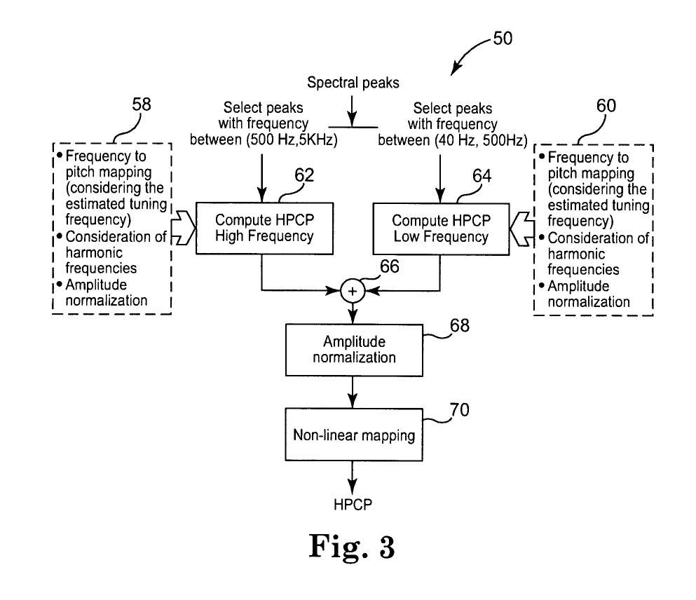

In some embodiments, and as discussed further with respect to FIG. 3, a band preset/frequency filtering step can then be performed separately for the high frequency band for peaks at a frequency higher than 500 Hz, and for the low frequency band for peaks at a frequency lower than 500 Hz. These two frequency bands are processed separately, and then the result normalized such that they are equally important to the HPCP computation. Such normalization may account for, for example, the predominance of the lower frequencies in the HPCP computation due to their higher energy.

During the frequency to pitch-class mapping stage (block 54), an HPCP vector can be computed based on the global tuning frequency determined during the pre-processing stage (block 52). The HPCP vector can be defined generally by the following equation:

$$HPCP ( n ) = {\sum }_{i = 1}^{nPeaks} w ( n , {f}_{i} ) \cdot {a}_{i}^{2} \\ n = 1 … size \qquad ( 4 )$$

where:

aᵢ corresponds to the magnitude (in linear units) of a spectral peak;

fᵢ corresponds to the frequency (in Hz) of a spectral peak; and

nPeaks corresponds to the number of peaks detected in the peak detection step.

The w(n,fᵢ) function in equation (4) above can be defined as a weighting window (cos) for the frequency contribution. Each frequency fᵢ contributes to the HPCP bin(s) that are contained in a certain window around this frequency value. For each of those bins, the contribution of the peak i (the square of the peak linear amplitude |aᵢ|²) is weighted using a cos² function around the frequency of the bin. The value of the weight depends on the frequency distance between fᵢ and the center frequency of the bin n, fₙ, measured in semitones, as can be seen from the following equations:

$$\begin{matrix}w ( n , {f}_{i} ) = \{ \begin{matrix}{cos}^{2} ( \frac{π}{2} \cdot \frac{d}{0.5 \cdot l} ) & if \vert d \vert \leq 0.5 \cdot l \\ 0 & if \vert d \vert > 0.5 \cdot l\end{matrix} & ( 5 ) \\ d = 12 \cdot {log}_{2} ( \frac{{f}_{i}}{{f}_{n}} ) + 12 \cdot m & ( 6 )\end{matrix}$$

where:

m is the integer that minimizes the module of the distance |d|; and

l is the window size in semitones.

In use, the weighting window minimizes the estimation errors that can occur when there are tuning differences and inharmonicity present in the spectrum.

A weighting procedure can also be employed to take into consideration the contribution of the harmonics to the pitch class of its fundamental frequency. Each peak frequency fi has a contribution to the frequencies having fᵢ as a harmonic frequency (fᵢ, fᵢ/2, fᵢ/3, fᵢ/4, . . . fᵢ/n harmonics). The contribution decrease along frequencies can be determined using the following equation:

wₕₐᵣₘ(n)=sⁿ⁻¹ (7)

where s<1, in order to simulate that the spectrum amplitude decreases with frequency.

The interval resolution selected by the user is directly related to the size of the HPCP vector. For example, an interval resolution of one semitone or 100 cents would yield a vector size of 12, one third of semitone or 33 cents would yield a vector size of 36, a 10 cent resolution would yield a vector size of 120, and so forth. The interval resolution influences the frequency resolution of the HPCP vector. As the interval resolution increases, it is generally easier to distinguish frequency details such as vibrato or glissando, and to differentiate voices in the same frequency range. Typically, a high frequency resolution is desirable when analyzing expressive frequency evolutions. On the other hand, increasing the interval resolution also increases the quantity of data and the computation cost.

During the post-processing stage (block 56), an amplitude normalization step is performed so that every element in the HPCP vector is divided by the maximum value such that the maximum value equals 1. The two HPCP vectors corresponding to the high and low frequencies, respectively, are then added up and normalized with respect to each other. A non-linear mapping function may then be applied to the normalized vector. In some embodiments, for example, the following non-linear mapping function may be applied to the HPCP vector:

Example Non-Linear Mapping Function

```
for(k=0; k<HPCPSize; k++) {
  HPCP[k] = sinf(HPCP[k]*PI*.5);
  HPCP[k] *= HPCP[k];
  if (HPCP[k] < 0.6)
    HPCP[k] *= HPCP[k]/0.6 * HPCP[k]/0.6;
}
```

FIG. 3 is a block diagram showing an illustrative implementation of the method 50 of FIG. 2 using band preset and frequency filtering to obtain an HPCP vector. As shown in FIG. 3, the HPCP vector can be obtained by performing frequency to pitch mapping, considering the estimated tuning frequency (e.g., A440) and its harmonic frequencies (blocks 58 and 60). In certain embodiments, a weighting technique may be used to make the harmonics contribute to the pitch class of its fundamental frequency, as discussed above. From this mapping, an HPCP high frequency value (block 62) and HPCP low frequency value (block 64) can be computed using selected peaks within a particular frequency range. In certain embodiments, for example, the selection of a high frequency range between about 500 Hz to about 5 KHz can be used in computing the HPCP high frequency value (block 62) whereas the selection of a low frequency range between about 40 Hz and about 500 Hz can be used in computing the HPCP low frequency value (block 64. Other ranges are possible, however.

Once computed, the HPCP high frequency value (block 62) and HPCP low frequency value (block 64) can then be combined together (block 66). An amplitude normalization process (block 68) can then be performed so that every element in the combined HPCP vector is divided by the maximum value such that the maximum value is equal to 1. A non-linear function (block 70) can then be applied to the normalized values, resulting in the HPCP vector.

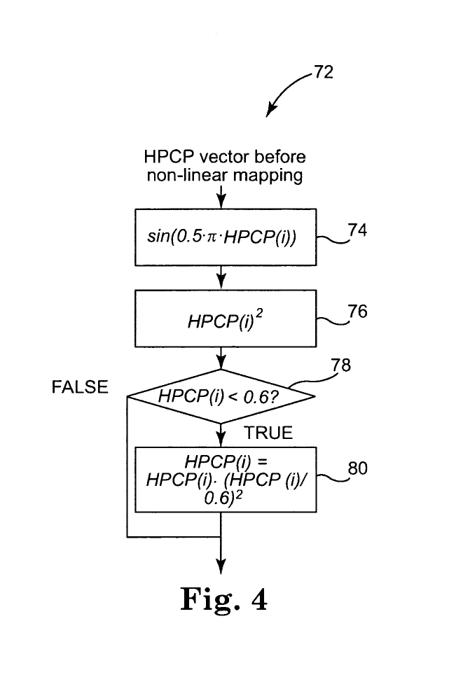

FIG. 4 is a block diagram showing an illustrative method 72 for providing non-linear mapping to the amplitude normalized HPCP vector. FIG. 4 may correspond, for example, to one or more of the steps (e.g., block 70) shown in FIG. 3. As shown in FIG. 4, the method 72 can include the steps of applying a sine function to the HPCP vector (block 74), applying a squaring function (block 76), comparing the result against a factor (block 78), and applying a mapping to the result (block 80) if the result is less than the factor.

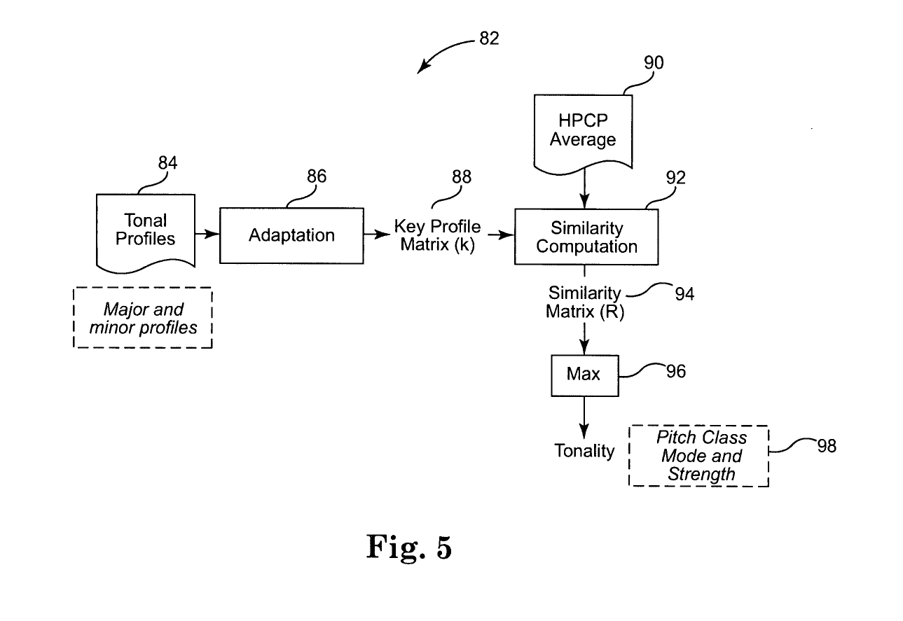

FIG. 5 is a block diagram showing an illustrative method 82 for obtaining a tonality estimation using the HPCP vector. As shown in FIG. 5, the average of the HPCP vector (block 90) can be computed for all of the audio piece in order to estimate the global tonality, or alternatively for a certain segment of the audio piece in order to obtain a sequence of tonality values, one for each segment (for tracking the evolution of the tonality). If the segment size is small (e.g., about 1 second), the tonality estimation is equal to a chord estimation. In the illustrative embodiment, the method 82 includes the definition of two vectors, a major and minor tonal profile (block 84), which are adapted (block 86) to generate a key profile matrix (block 88). This key profile matrix contains the tonal profile vector for each of the 24 possible keys. The HPCP average vector 90 is compared with each of the vectors of the key profile matrix in a similarity computation process (block 90), which results in the creation of a similarity matrix (block 94). The maximum value of the similarity matrix results in the estimated tonality for the audio piece. The estimated tonality may be defined by the note name (i.e., pitch dass), the mode (major or minor), and the strength (block 98), which is equal to the value of the similarity matrix.

The descriptors that can be derived from the HPCP vector can include, but are not limited to, diatonic strength, local tonality (key), tonality (key/chord), key and chord histograms, equal tempered deviations, and a non tempered/tempered energy ratio. The diatonic strength is the key strength result from the key estimation algorithm, but using a diatonic profile. It may be the maximum correlation with a diatonic major or minor profile, representing the chromacity of the musical piece.

The local tonality (key) descriptor provides information about the temporal evolution of the tonality. The tonality of the audio piece can be estimated in segments using a sliding window approach in order to obtain a key value for each segment representing the temporal evolution of the tonality of the piece.

The tonality (key/chord) contour descriptor is a relative contour representing the distance between consecutive local tonality values. Pitch intervals are often preferred to absolute pitch in melodic retrieval and similarity applications since melodic perception is invariant to transposition. For different versions of the same song that can be transposed to adapt the song to a single or instrument tessitura, for example, the tonality contour descriptor may permit a relative representation of the key evolution of the song. The distance between consecutives tonalities can be measured in the circle of fifths: a transition from C major to F major may be represented by −1, a transition from C major to A minor by 0, a transition from C major to D major by +2, etc.

Key and chord histograms can be derived from the local tonality computed over segments of an audio piece. In certain embodiments, for example, the total number of different tonalities (i.e., keys/chords) present in an audio piece can be determined. The most repeated tonality and the tonality change rate for an audio piece can also be determined.

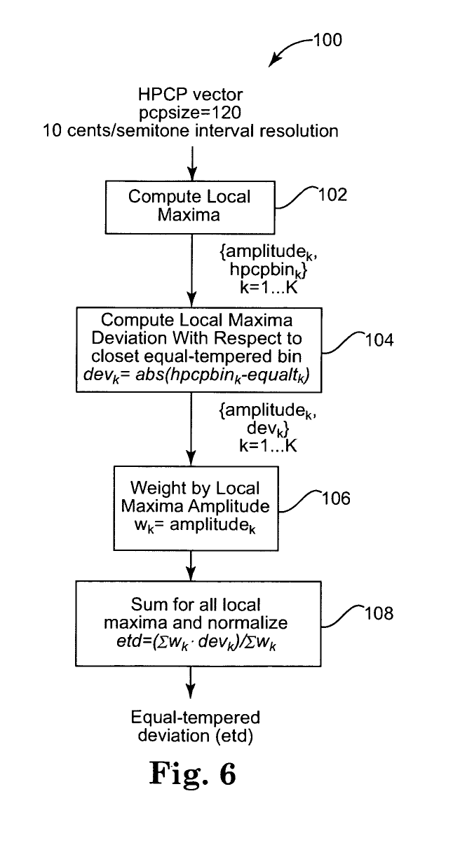

The equal-tempered deviation descriptor can be used to measure the deviation of the local maxima of an HPCP vector. As can be further seen in FIG. 6, for example, an illustrative method 100 of computing an equal-tempered deviation (with a pcpsize=120 bins (10 cents per semitone) from equal-tempered bins) can include the steps of computing a local maximum of the HPCP vector (block 102), computing the deviations from equal tempered (abs) bins (block 104), weighting the local maxima amplitude (block 106), and then summing all of the local maxima and normalizing the values (block 108).

A non-tempered/tempered energy ratio between the amplitude of the non-tempered bins of the HPCP vector and the total energy can also be determined using the HPCP vector. Normally, the HPCP vector should be computed with a high interval resolution (e.g., 120 bins, 10 cents per semitone).

Chord, Key and Local Tonality Detection

An illustrative method of detecting all of the chords in a song or audio piece using HPCP vectors will now be described. A chord is a combination of three or more notes that are played simultaneously or almost simultaneously. The sequence of chords that form an audio piece is extremely useful for characterizing a song.

The detection of chords within an audio piece may begin by obtaining an HPCP 36-bin feature vector per frame representing the tonality statistics of the frame. Then, the HPCP is averaged over a 2 second time. At a sampling rate of 44,100 Hz and with frames of a size 4096 bins with a 50% overlap, 2 seconds corresponds to 43 frames. Thus, each of the elements of the HPCP is averaged with the same element (i.e. at the same position in the vector of the subsequent 42 frames).

Once the averaged HPCP is obtained, the chord corresponding to the averaged HPCP vector is extracted by correlating the average HPCP vector with a set of tonic triad tonal profiles. These tonal profiles can be computed after listening tests and refined to work with the HPCP. The process can then be repeated for each successive frame in the audio piece, thus producing a sequence of chords within the audio piece. If instead of averaging HPCP vectors over a 2 second time they are averaged over the whole duration of the audio piece, the result of the correlation with a set of tonal profiles would produce the estimated key for the audio piece.

Cover Versions Detection

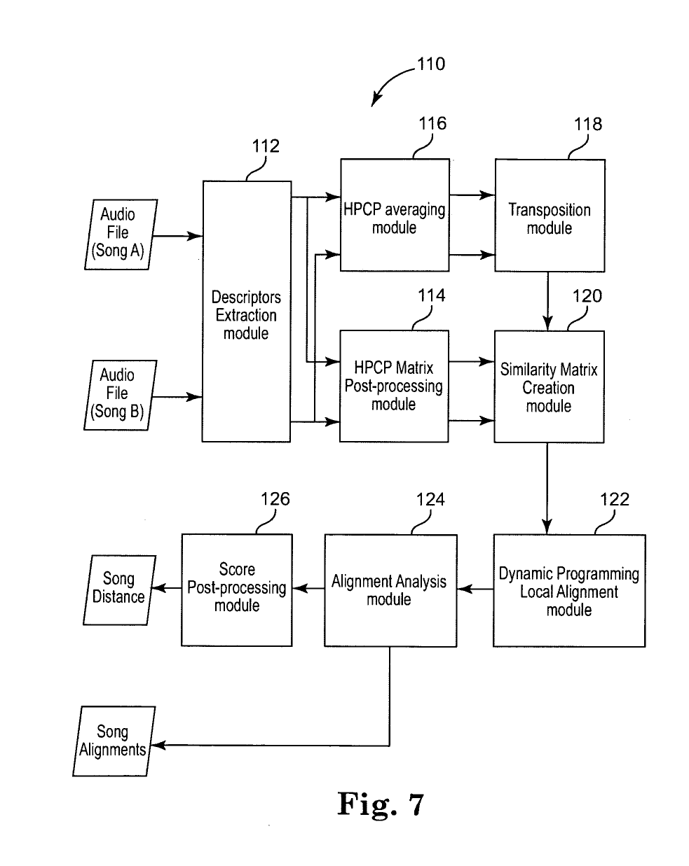

FIG. 7 is a block diagram of an illustrative music similarity system 110 for finding similarities between songs. As shown in FIG. 7, the system 110 includes an HPCP descriptors extraction module 112, an HPCP matrix post-processing module 114, an HPCP averaging module 116, a transposition module 118, a similarity matrix creation module 120, a dynamic programming local alignment module 122, an alignment analysis module 124, and a score post-processing module 126.

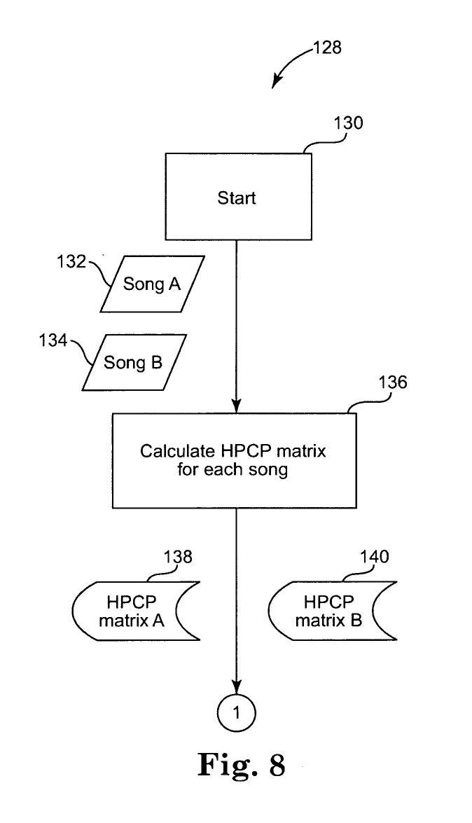

An illustrative method 128 for detecting cover songs using the music similarity system 10 of FIG. 7 will now be described with respect to FIGS. 8-18. As shown in FIG. 8, the method 128 may begin generally at block 130 with the step of inputting two audio files each representing a song 132,134. The songs 132,134 may represent, for example, an original version of a song and a cover version of the song.

Each of the audio files containing the songs 132,134 is transmitted to the HPCP descriptors extraction module 112, which calculates an HPCP vector (138,140) for each of the audio files (block 136). As further shown in FIG. 9, each of the HPCP vectors is inputted to the HPCP matrix post-processing module 114, which refines the HPCP vectors 138,140 and provides both vectors 144,146 to the similarity creation module 120. The HPCP vectors 138,140 are also transmitted to the HPCP averaging module 116, which calculates (block 144) a global HPCP 150,152 from each HPCP vector 138,140. The global HPCPs 150,152 are then provided to the transposition module 118, which calculates (block 154) a transposition index 156 that is transmitted to the similarity matrix creation module 120. At block 158, the similarity matrix creation module 120 receives as an input the two HPCP matrices 144,146, one for each of the audio files 132,134, and the transposition index 156 is used to produce a similarity matrix 160.

As further shown in FIG. 10, the similarity matrix 160 is then transmitted to the dynamic programming local alignment module 122, which calculates (block 162) a matrix of local alignments 164 between the two songs 132,134 that is transmitted to the alignment analysis module 124. At block 166, the alignment analysis module 124 then processes the matrix 164 to produce an alignment score 168 and the song alignments 170. At block 172, the alignment score 168 is transmitted to the score post-processing module 126 that gives the final output, which in some embodiments is a song distance value 174 for the audio files 132,134.

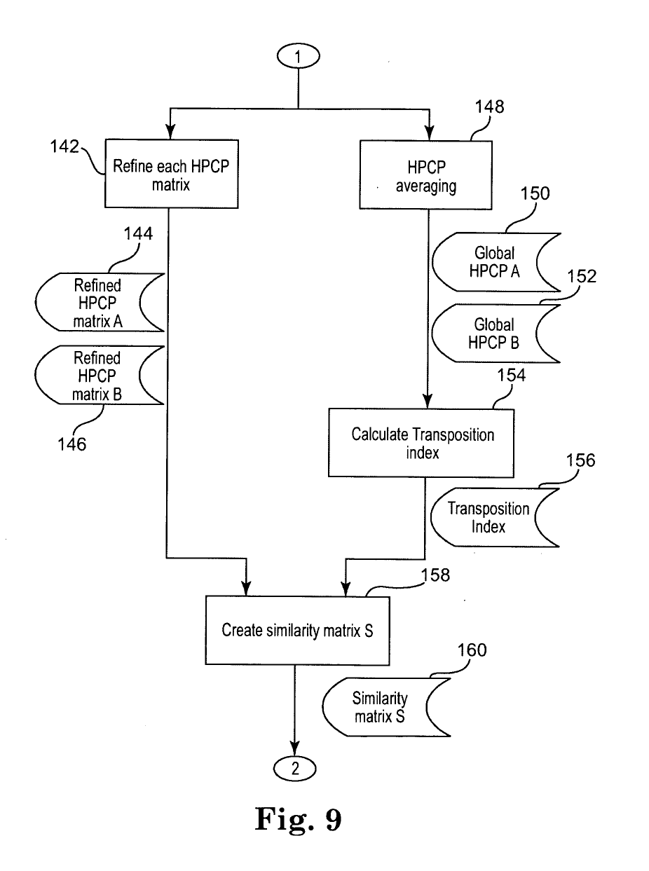

FIG. 11 is a block diagram showing an illustrative input and output of the descriptors extraction module 112. As shown in FIG. 11, the module 112 takes as an input an audio file 176. In some embodiments, for example, the audio file 176 may comprise a song in a WAV, 44,100 Hz, 16-bit format, although other formats are possible.

Each song 132,134 from the audio file 176 is decomposed into short overlapping frames, with frame-lengths ranging from 25 ms to 500 ms. For example, a frame-length of 96 ms with 50% overlapping can be utilized. Then, the spectral information of each frame is processed to obtain a Harmonic Pitch Class Profile (HPCP) 178, a 36-bin feature vector representing the tonality statistics of the frame. Then, the feature vectors are normalized by dividing every component of the vector by the maximum value of the vector. As there were no negative values of h, each component is finally comprised between 0 and 1 based on the following equation:

$${\vec{h}}^{′} = \frac{\vec{h}}{( max ( \vec{h} ) )} \qquad ( 8 )$$

Once all frames are analyzed, a sequence of vectors is obtained that can be stored as columns in a matrix 138,140 called an HPCP matrix:

HPCP=└\vec{h}₁\vec{h}₂ . . . \vec{h}ₙ┘ (9)

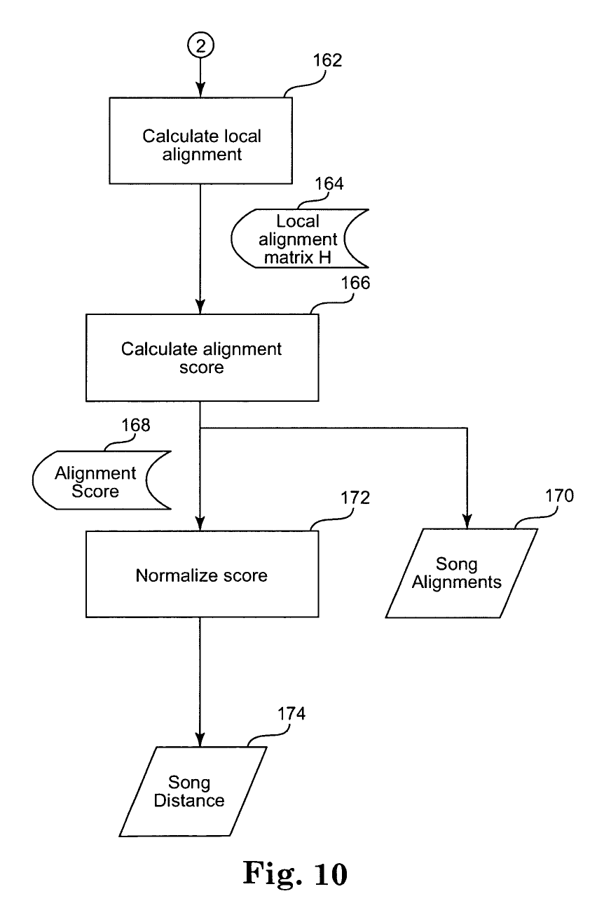

FIG. 12 is a block diagram showing how the HPCP matrix 138,140 is refined using the HPCP post-processing module 114 of FIG. 7. Using the HPCP post-processing module 114, inharmonic or silent frames are removed from the HPCP matrix 138,140, thus producing a refined HPCP matrix 144,146. These can be detected by looking at the vectors that have an infinite value, which means that their maximum was zero.

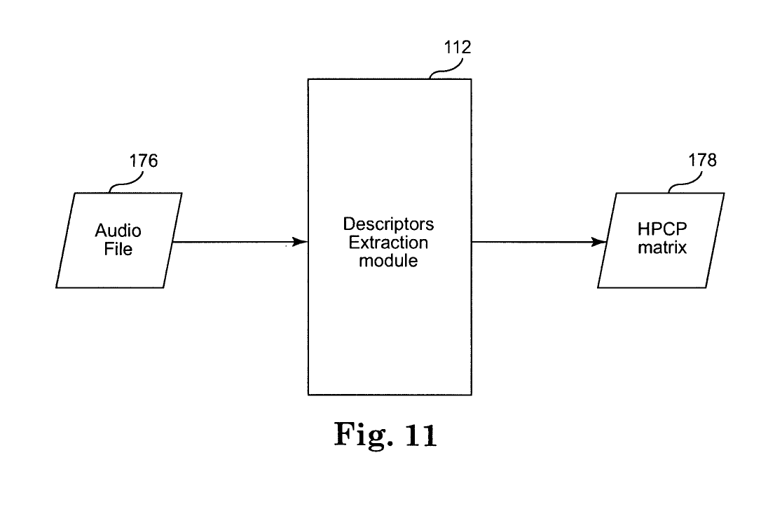

Also, as further shown in the block diagram of FIG. 13, the mean value of the valid vectors over all frames is calculated in the HPCP averaging module 116 and normalized, thus producing a global HPCP matrix 150,152. This can be understood with respect to equations (10) and (11) below:

$$\begin{matrix}Global \vec{H} PCP = {\sum }_{i = 1}^{n} {\vec{h}}_{i} & ( 10 ) \\ Global \vec{H} {PCP}^{′} = \frac{Global \vec{H} PCP}{max ( Global \vec{H} PCP )} & ( 11 )\end{matrix}$$

Alternatively, and in other embodiments, consecutive vectors may be averaged by summing several matrix consecutive columns and dividing by the maximum value obtained based on the following relationships. This can be seen from equations (12) and (13) below:

$$\begin{matrix}{\vec{h}}^{′} = {\sum }_{k = 1}^{X} {\vec{h}}_{i * X + k} & ( 12 ) \\ {\vec{h}}_{i}^{″} = \frac{{\vec{h}}_{i}^{′}}{max ( {\vec{h}}_{i}^{′} )} & ( 13 )\end{matrix}$$

If larger groups are chosen, time latency of subsequent processes improves (as the number of frames or vectors to process decreases), but the accuracy of the method becomes poorer. Example choices for X are X=5 or X=10, which results in a frame length near 0.25 and 0.5 seconds, respectively.

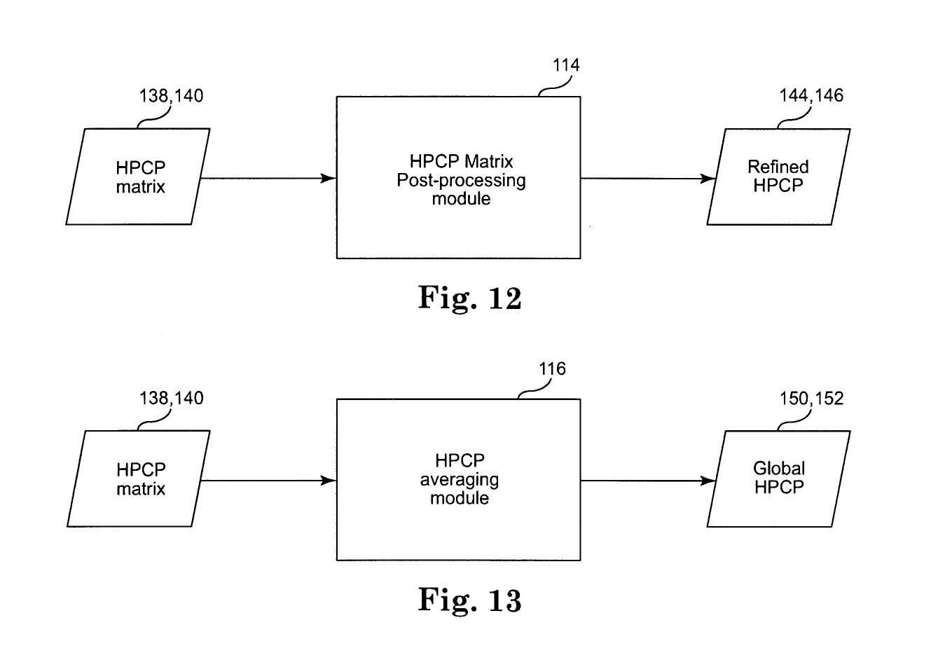

FIG. 14 is a block diagram showing the calculation of a transposition index 156 using the transposition module 118. The result of the HPCP averaging module 116 is used as an input for the transposition module 118. Alternatively, other features similar to HPCP may also be used. For example, in one alternative embodiment a chroma feature vector may be used. Furthermore, the number of components or bins of these feature vectors may vary from 12 to 36, or even higher values. However, since each bin represents a note or a part of a note, the number of components chosen has to be a multiple of 12. Therefore, selecting a higher number of bins improves accuracy of the feature vectors, but also increases the computational load of the method.

The transposition module 118 can be used to calculate a transposition index 156 of the two songs 130,132 as follows:

t=arg max_{0≦id≦N-1}{Global\vec{H}PCP_{A}·circularshift(Global\vec{H}PCP_{B},id)} (14)

where “·” indicates a dot product, and circularshift(h,id) is a function that rotates a vector (h) id positions to the right. A circular shift of one position is a permutation of the entries in a vector where the last component becomes the first one and all the other components are shifted.

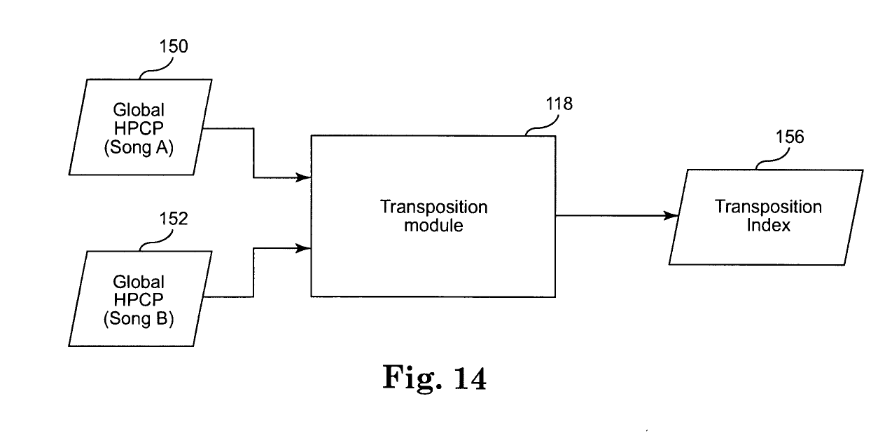

FIG. 15 is a block diagram showing the calculation of a similarity matrix using the similarity matrix creation module 120. The transposition index t calculated by the transposition module 118 is used to transpose one refined HPCP matrix with respect to the other so that both are in the same tonal reference or key. For each column of only one of the two HPCP matrices:

\vec{h}ᵢ′[n]=\vec{h}ᵢ[((n+t))_{N}] (15)

where:

N is the number of components of the vector; and

((X))_{N} is the modulo N of x. For clarity reasons a circularshift(h[x],y) will also be expressed as h[((x+y))_{N}].

From the two HPCP matrices, a similarity matrix 160 can be constructed where each element (i,j) within the matrix 160 is the result of the following equations:

S(i, j)=1 if OTI(i, j)=0 (16)

S(i,j)=−1 otherwise (17)

The Optimal Transposition Index (OTI) is calculated as:

OTI(i,j)=arg max_{0≦id≦N-1}{\vec{h}_{A,i}·circularshift(\vec{h}_{B,j}((t+id))_{N})} (18)

In the above equation (18), N is the number of components of the vectors h (columns of the HPCP matrix), “·” indicates a dot product, and circularshift( ) is the same function as described previously. Finally, t corresponds to the transposition index 156 calculated by the transposition module 118 and ((X))_{N} is the modulo N of x.

Equation (18) may be computationally costly to compute (O(2*N*N) operations, where N is the number of components of a vector. As an alternative, and in some embodiments, a Fourier Transform can be used which may result in obtaining a faster computation of the similarity matrix 160. Note that the part inside argmax in the equation (18) is a circular convolution. This results in the following:

$${\sum }_{n = 0}^{N - 1} {h}_{A , i} [ n ] \cdot {h}_{B , i} [ {( ( n + m ) )}_{N} ] ∝ FFT ( FFT ( {h}_{A , i} ) \cdot {FFT ( {h}_{B , i} )}^{C} ) \qquad ( 19 )$$

where:

N is the number of components of the vector;

((X))_{N} is the modulo N of x,

FFT is the Fast Fourier Transform; and

C indicates the complex conjugate.

The value of t can be obtained by determining the argument that leads to a maximum value of the result of both equations (18) and (19), while the latter equation (19) is faster to calculate due to the speed of the FFT algorithm (O(N*log(N)) operations).

A similarity matrix 160 may also be constructed by any other suitable similarity measure between HPCP vectors such as the Euclidean distance, cosine distance, correlation, or histogram intersection.

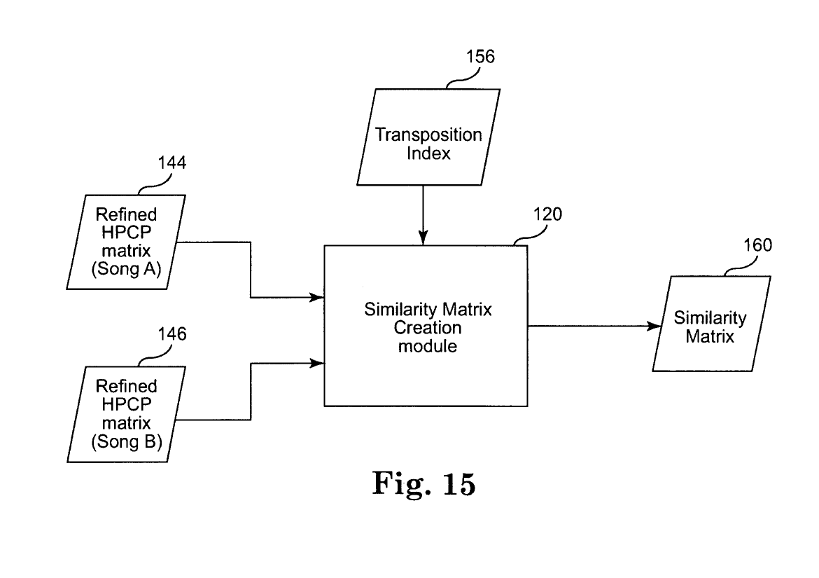

FIG. 16 is a block diagram showing the calculation of the local alignment matrix 164 using the dynamic programming local alignment module 122. As shown in FIG. 16, the similarity matrix 160 obtained from the similarity matrix creation module 120 is the only input of the module 122. In use, the module 122 is configured to perform a dynamic programming local alignment on the similarity matrix 160, producing a local alignment matrix 164. If, for example, one song is n frames long and the other song is m frames long, then the resultant local alignment matrix 164 would have the dimensions (n+1,m+1). The local alignment matrix 164 can be initialized as follows:

H(0,i)=H(j,0)=0 (20)

H(1,i)=S(1,i) and H(j,1)=S(j,1) (21)

Then, for elements (i,j) where i,j>1, the following recursive relation is applied:

H(i, j)=max{0,H(i−1, j−1)+S(i,j),H(i−1, j−2)+S(i,j),H(i−2,j−1)+S(i,j)} (22)

Different penalties for negative S(i,j) can be added in the above relation. This can be accomplished by subtracting the desired penalty to the elements inside the max expression that have a negative S(i,j). Adding penalties allows for the method to be tuned. The higher the penalty the less tolerance for differences between song alignments. Thus, for a higher penalty, the inter-song contents have to be more similar in order to be recognized as the same song.

In an alternative embodiment, the computation of the local alignments can be performed using, for example, a Smith-Waterman or FASTA algorithm. A Dynamic Time Warping recurrent relation, but with a similarity matrix having positive and negative values, can also be utilized to yield to the desired local alignments.

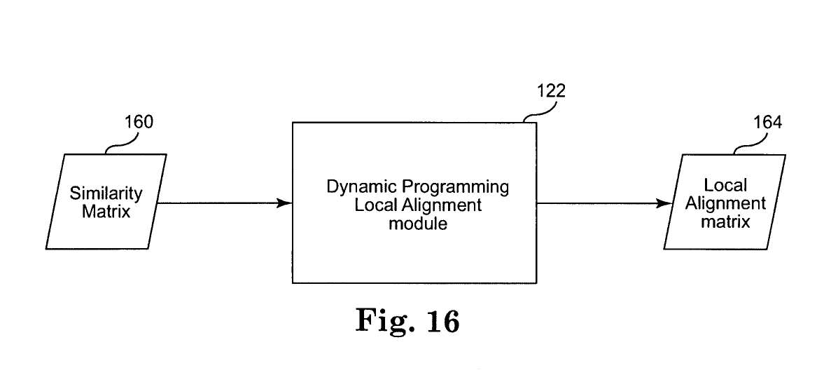

FIG. 17 is a block diagram showing the calculation of the song alignments 170 and song distance 174 using the alignment analysis module 124 and score post-processing module 126. As shown in FIG. 17, the alignment analysis module 124 receives as an input a local alignment matrix 164, which comprises high peak values corresponding to strong similarity points. These peaks can then be backtracked by a backtracking algorithm in order to determine a path.

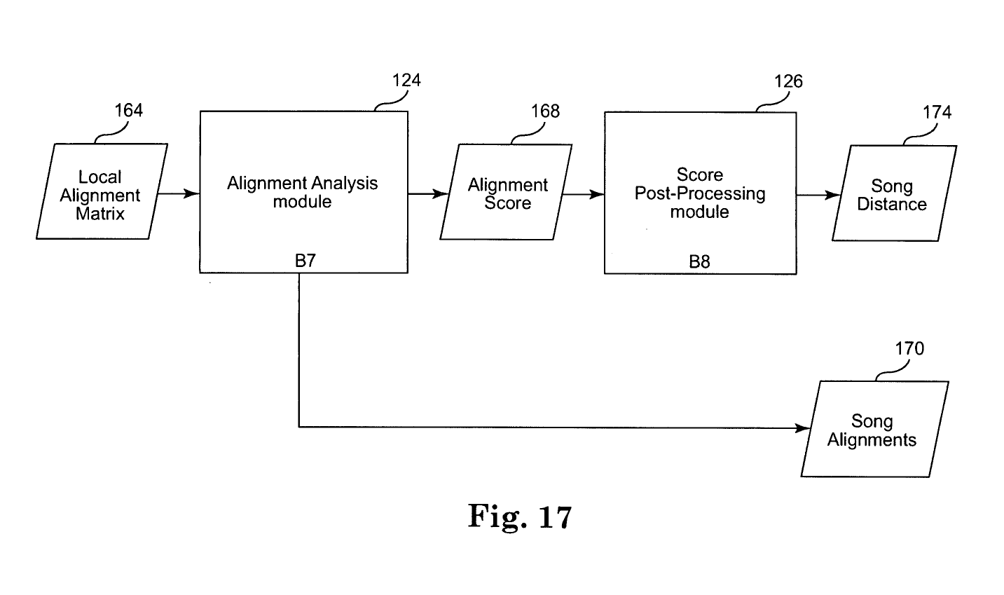

FIG. 18 is a flow chart showing an illustrative backtracking algorithm 180 that can be used to determine a similarity path. The algorithm 180 may begin generally at block 182 with the step of picking a position (i,j) where a peak is located. Once a position is selected, the algorithm 180 next determines the values of H(i−1,j), H(i,j−1), H(i−1,j−1) and selects a maximum value max(H(i−1,j), H(i,j−1), H(i−1,j−1), as indicated generally at block 184.

At block 186, a decision depending on the maximum value found is then made. If the maximum value is not 0, then the algorithm 180 records indexes corresponding to the maximum value found in the path (188), which is then fed as an initial position back to the step at block 184. If the maximum value found in the step at block 186 is 0, then the complete path is recorded (block 190) and kept as a possible song alignment 170.

While FIG. 18 shows an illustrative backtracking algorithm 180 that can be used to compute possible song alignments 170, other backtracking algorithms can also be used. One alternative backtracking that can be used to compute the song alignments 170 is described, for example, in Waterman and Eggert, “A New Algorithm for Best Subsequence Alignments with Application to tRNA-rRNA Comparisons”, published in the Journal of Molecular Biology, vol. 197 (pp. 723-728), 1987, which is incorporated herein by reference in its entirety.

The backtracking algorithm 180 may be run for each of the peaks. The starting point or initial peak will typically be the maximum value of the local alignment matrix 164. Once the path is completed for the initial peak, the path may then be calculated for the second highest value of the local alignment matrix 164, and so forth. A path representing the optimal alignment between sub-sequences of the two songs is then created as the backtracking algorithm 180 calculates each of the peak positions and stores their values in the local alignment matrix 164.

While the backtracking algorithm 180 may be focused in the first path found with a starting point which is the maximum value of the local alignment matrix, different paths can also be found. These different paths could be used for other applications such as segmentation, comparing different interpretations of different passages of the same song, and so forth.

Referring back to FIG. 17, once the value of the highest peak of the local alignment matrix 164 is determined, the alignment score 168 is obtained by:

score=max(H) (23)

Finally, the alignment score 168 is normalized by the maximum path length using the score post-processing module 126. This results in the song distance 174 using an inverse relation:

$$distance = \frac{n + m}{score} \qquad ( 24 )$$

where n and m is the length in frames of songs 132 and 134, respectively.

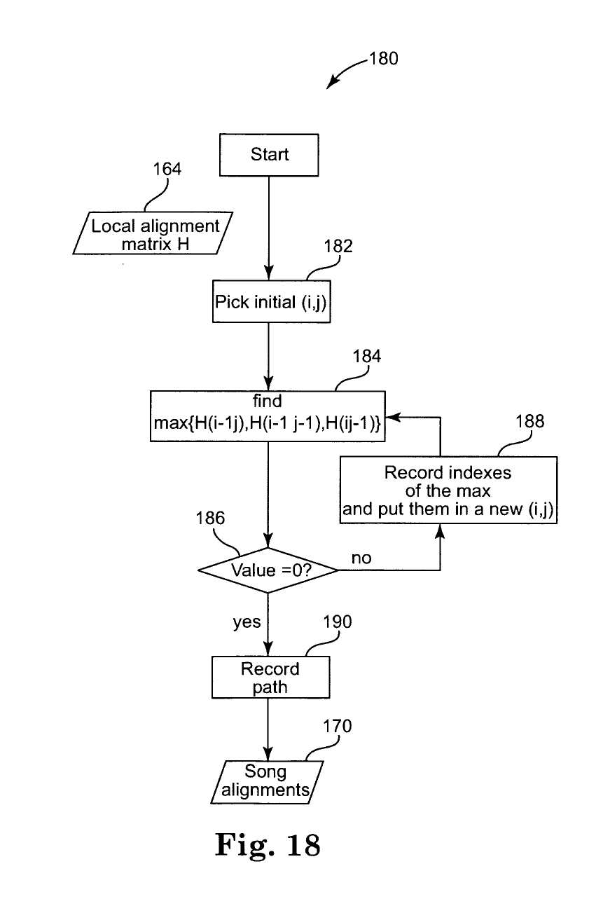

The song distance 174 generated by the score post-processing module 126 can be used to determine the similarity of the two songs based on their tonal sequences, and the optimal alignments between them. The song distance 174 between two songs can be used in any system where such a measure is needed, including a cover song identification system in which low values of the song distance 174 indicate a greater probability that the songs 132,134 are the same, or a music recommendation system in which it is desired to sort the songs 132,134 according to a tonal progression similarity criterion. In some cases, the song distance 174 can be the input of another process or method such as a clustering algorithm that can be used to find groups of similar songs, to determine hierarchies, or to perform some other desired function. In FIG. 19, an example of a dendrogram 192 made with the song distances 174 of a small group of known songs is illustrated.

The optimal alignment (or path) found between two songs is a summarization of the intervals that they both have in common (i.e., where the tonality sequences coincide. For example, if a path starts at position (i,j) and ends at position (i+k₁,j+k₂), this indicates that the frames from i to i+k₁ for the first song (and from j to j+k₂ for the second song) are similar and belong to the same tonal sequence.

In some embodiments, the path or song alignment 170 can be used to detect tempo differences between songs. If there is an alignment such as (1,1), (2,2), (3,3), (4,4), . . . , it is possible to infer that both songs are aligned and therefore should have a similar tempo. Instead, if song A and song C have an alignment like (1,1), (1,2), (2,3), (2,4), (3,5), (3,6), (4,7), . . . , then, it is possible to infer that the tempo of song C would be twice that of song A. Another application of the path or song alignment 170 is when the two songs are the same. In this case, the sequence between these frames (i and i+k₁) would correspond to the most representative (or repeated) excerpt of the song and the local alignment matrix 164 would have several peaks corresponding to the points of high self-similarity.

Western/Non-Western Music Descriptors

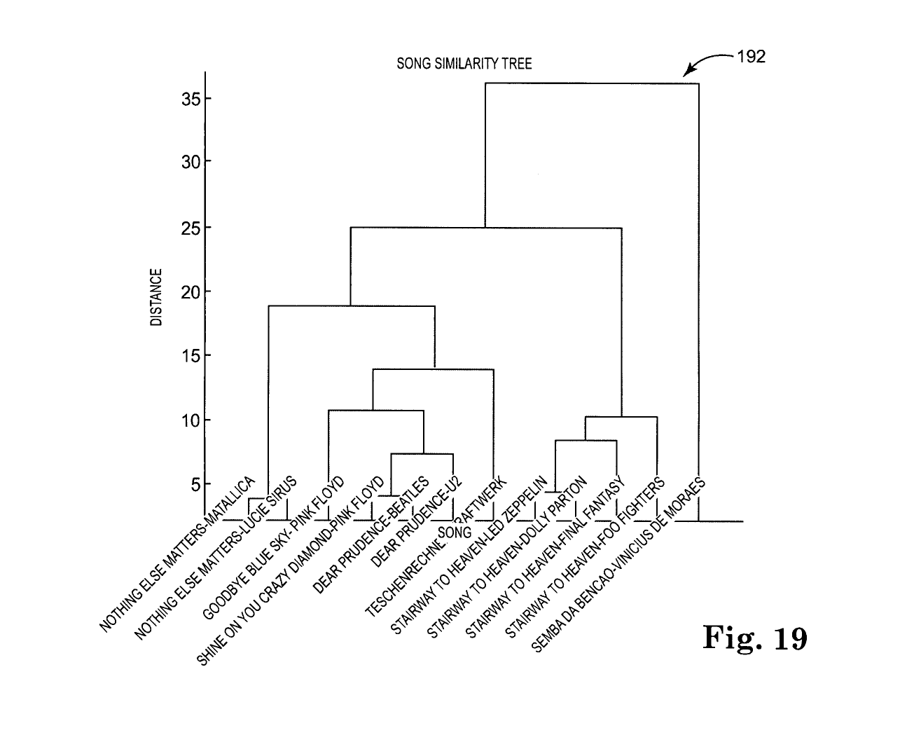

An illustrative method 194 of determining whether a song or audio piece belongs to a western musical genre or a non-western musical genre will now be described with respect to FIG. 20. Western music, or western culture, refers to music or cultures that have a European origin and most of its descendants. This term is often used in contrast to Asian, African or Arab cultural origins. Although this distinction is usually not sufficient to characterize a musical piece on its own, it is very useful in combination with other features such as tonal features or rhythm features for filtering after a similarity search. This filtering may help to avoid taking as similar two audio pieces with similar tonal features and similar rhythmical features but belonging to a different cultural genre. This may also take into consideration human perception in assessing the performance of the music similarity system.

In order to determine the cultural genre of an audio piece 196, some different criteria are taken into account in order to obtain a western/non-western classification descriptor 214. As shown in FIG. 20, this may include, for example, the high resolution pitch class distribution (HPCP), the tuning frequency 200, the octave centroid 202, the dissonance 204, the equal-tempered deviation 206, the non-tempered to tempered energy ratio 208, and the diatonic strength 210. Other factors in addition to, or in lieu of, those shown in FIG. 20 may also be taken into consideration in order to obtain a western/non-western classification descriptor 214.

The high-resolution pitch class distribution 198 may be determined first by calculating the Harmonic Pitch Class Profile (HPCP) on a frame by frame basis, as discussed previously. In some embodiments, this calculation can be performed with 100 ms overlapped frames (i.e., a frame length of 4096 samples at 44,100 Hz, overlapped 50% with a hop size of 2048). Other parameters are also possible, however.

In western music tradition, the frequency used to tune a musical piece is typically a standard reference A, or 440 Hz. A measure of the deviation with 440 Hz is thus very useful for cultural genre determination. The reference frequency is estimated for each analysis frame by analyzing the deviation of the spectral peaks with respect to the standard reference frequency of 440 Hz. A global value is then obtained by combining the frame estimates in a histogram.

Traditional western music scale notes are often separated by equally-tempered tones or semitones with at most 12 pitches per octave. Therefore, the frequency ratio between consecutive semitones is constant and equal to st=12\sqrt{2}. Typically other musical traditions use scales that include other intervals or a different number of pitches, and are thus distinguishable.

The equal-tempered deviation 206 measures the deviation of the HPCP local maxima from equal-tempered bins. In order to compute this, a set of local maxima are extracted from the HPCP, {posᵢ, aᵢ}, i=1 . . . N. Their deviation from closest equal-tempered bins weighted by their magnitude and normalized by the sum of peak magnitudes can then be calculated based on the following formula:

$$Etd = \frac{\sum {a}_{i} \cdot abs ( {pos}_{i} - {equal\_tempered}_{i} )}{\sum {a}_{i}} \qquad ( 25 )$$

The non-tempered to tempered energy ratio 208 represents the ratio between the HPCP amplitude of non-tempered bins and the total amplitude, and can be expressed as follows:

$$ER = \frac{\sum {HPCP}_{iNT}}{\sum {HPCP}_{i}} \\ i = 1 … hpcpsize \qquad ( 26 )$$

where hpcpsize=120 and HPCP_{iNT} are given by the HPCP positions related to the equal-tempered pitch classes.

The diatonic strength 210 represents the maximum correlation of the HPCP 198 and a diatonic major profile ring-shifted in all possible positions. Typically, western music uses a diatonic major profile. Thus, a higher score in the correlation would indicate that the audio piece 196 is more likely to belong to a western music genre than a non-western music genre.

HPCP 198 and the related descriptors 206,208,210 can be used to map all the pitch class values to a single octave. This introduces an inherent limitation that consists in the inability for differentiating the absolute pitch height of the audio piece 196. In order to take into account the octave location of the audio piece, an octave centroid 202 feature is computed. A multi-pitch estimation process is then applied to the spectral analysis. An exemplary multi-pitch estimation process is described for example, in “Multipitch Estimation And Sound Separation By The Spectral Smoothness Principle” by Klapuri, A., IEEE International Conference on Acoustics, Speech and Signal Processing (2001),” which is incorporated herein by reference in its entirety. A centroid feature is then computed from this representation on a frame by frame basis. Statistics from the frame values such as the mean, variance, min and max are then computed as global descriptors for the audio piece 196.

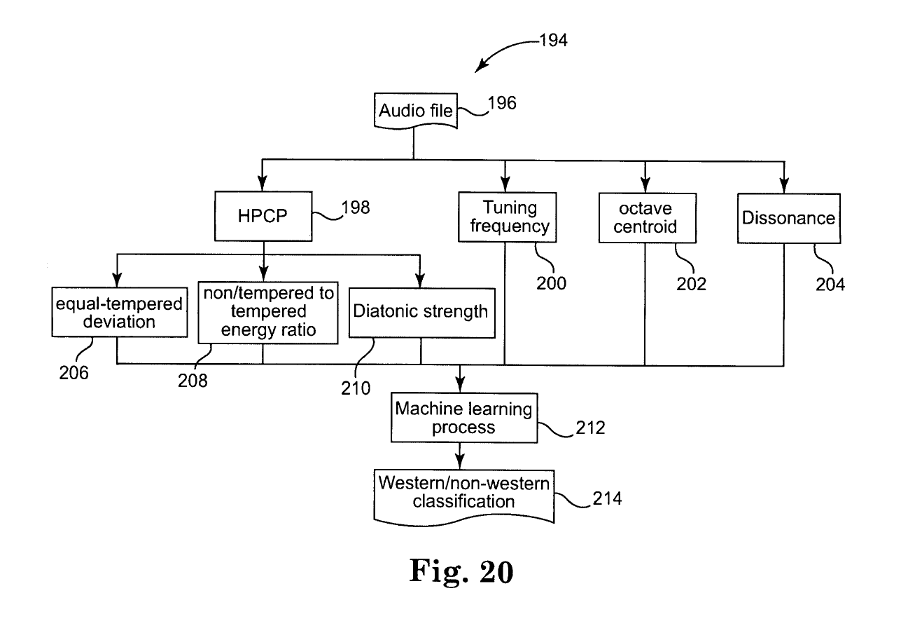

The dissonance 204 of the audio piece 196 is also calculated. An exemplary method for computing the dissonance 204 of the audio piece 196 is described, for example, with respect to FIG. 21 herein.

Finally, once all of these features are calculated for a set of known audio pieces 196, the audio pieces 196 and their classification are then fed as training data to an automatic classification tool, which uses a machine learning process 212 to extract data. An example of an automatic classification tool that uses machine learning techniques is the Waikato Environment for Knowledge Analysis (WEKA) software developed by the University of Waikato.

For classifying an audio piece, the aforementioned features are extracted from the audio piece 196 and fed to the automatic classification tool that classifies it as belonging to either a western music genre or to a non-western music genre 214. This classification 214 can then be used in conjunction with other features (e.g., tonal features, rhythm features, etc.) for filtering a similarity search performed on the audio piece 196.

### Dissonance/Consonance Descriptors

Dissonance of a Song or Audio Piece

The dissonance of an audio piece may be generally defined as the quality of a sound which seems unstable, and which has an aural need to resolve to a stable consonance. Opposed to dissonance, a consonance may be generally defined as a harmony, chord or interval that is considered stable. Although there are physical and neurological factors important to understanding the idea of dissonance, the precise definition of dissonance is culturally conditioned. The definitions and conventions of usage related to dissonance vary greatly among different musical styles, traditions, and cultures. Nevertheless, the basic ideas of dissonance, consonance, and resolution exist in some form in all musical traditions that have a concept of melody, harmony, or tonality.

An illustrative method 216 of determining the dissonance of an audio piece will now be described with respect to FIG. 21. The dissonance descriptor can be represented by a real number comprised within the range [0,1], where a dissonance of 0 corresponds to a perfect consonance and a dissonance of 1 corresponds to a complete dissonance. As shown in FIG. 21, the method 216 can take as an input a digitized audio piece 218 sampled at a 44,100 Hz sampling rate. If the audio piece 218 has been digitized with a different sampling rate, then it can be re-sampled so the rate is 44,100 Hz. If the audio piece 218 is in a compressed format then it can be decompressed to a PCM format or other uncompressed format.

First, the audio piece 218 can be divided into overlapping frames. Each frame my have a size of 2048 samples and an overlap of 1024 samples, corresponding to a frame length of around 50 ms. If a different frame length is selected, then either the number of samples per frame must also be changed or the sampling rate must be changed. The number of samples can be linked to the sampling rate by correlating 1 second to 44,100 samples.

Next, each frame can be smoothed down to eliminate or reduce noisy frequencies. To accomplish this, each frame can modulated with a window function (block 220). In certain embodiments, this window function is a Blackman-Harris-62 dB function, but other window functions such as any low-resolution window function may be used.

Next, a frequency quantization of each windowed frame can be performed (block 222). In certain embodiments, for example, a Fast Fourier Transform can be performed. After the frequency quantization, a vector containing the frequencies with the corresponding energies can be obtained.

The resulting vector can then be weighted to take into consideration the difference in perception of the human ear for different frequencies. A pure sinusoidal tone with a frequency at around 4 kHz would be perceived as louder by the human ear than a pure tone of identical physical energy (typically measured in dB SPL) at a lower or higher frequency. Thus, in order to weigh frequencies according to the human ear, the vector can be weighted according to a weighting curve (block 224) such as that defined in standard IEC179. In certain embodiments, for example, the weighting curve applied is a dB-A scale.

Next, all local spectral maxima can be extracted for each frame (block 226). For this operation and for computational cost optimization reasons, only the frequencies within the range 100 Hz to 5,000 Hz are taken into consideration, which contain the frequencies present in most music. It should be understood, however, that the spectral maxima can be extracted for other frequency ranges.

Then, every pair of maxima separated by less than 1.18 of their critical band can be determined. The critical band is the specific area on the inner ear membrane that goes into vibration in response to an incoming sine wave. Frequencies within a critical band interact with each other whereas frequencies that do not reside in the same critical band are typically treated independently. The following formula assigns to each frequency a bark value:

CriticalBa nd[bark]=6·a sin h(f/600) (27)

where f corresponds to the frequency for which the bark value is being calculated. The width of a critical band at a frequency f1 would then be distance between f1 and a second frequency f2 that result in bark values that differ by a value of 1.

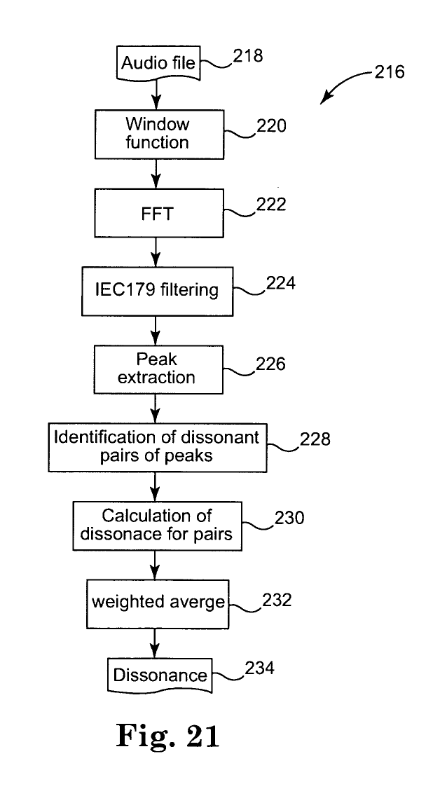

Once all pairs of peaks are determined (block 228), the dissonance of these pairs of frequencies can then be derived (block 230) from the relationship between their distance in bark values or critical bands and the resulting dissonance. A graph showing the relationship between the critical bandwidth or bark values and resulting dissonance/consonance is shown, for example, in FIG. 22.

The total dissonance for a single peak fᵢ may thus be calculated based on the following relation:

$$Dissonance ( {f}_{i} ) = \frac{{\sum }_{j = 1 , i \neq j}^{n} Dissonance ( {f}_{i} , {f}_{j} ) \cdot Energy ( {f}_{j} )}{{\sum }_{j = 1 , i \neq j}^{n} Energy ( {f}_{j} )} \qquad ( 28 )$$

where:

fⱼ represents every peak found at a distance less than the critical band for peak fᵢ;

Dissonance(fᵢ, fⱼ) is the dissonance for the pair of peaks fᵢ, fⱼ;

Energy(fⱼ) is the energy of the peak at f_{j,}; and

n represents the total number of maxima in the frame being processed.

The above calculation can be carried out for each of the determined maximum in the frame. Then, as shown in equation (29) below, the total dissonance for a single frame is:

$$Dissonance = \frac{{\sum }_{1}^{n} Dissonance ( {f}_{i} ) \cdot Energy ( {f}_{i} )}{{\sum }_{1}^{n} Energy ( {f}_{i} )} \qquad 29 )$$

where:

Dissonance(fᵢ) is the dissonance calculated previously for the peak at fᵢ;

Energy(fᵢ) is the energy of the peak at fᵢ; and

n represents the total number of maxima in the frame being processed.

Finally, the dissonance (block 234) of the audio file 218 is obtained by averaging the dissonance of all frames. In some embodiments, the dissonance (block) 234 can also be computed by summing a weighted dissonance (block 232) for each frame with the weighting factor being proportional to the energy of the frame in which the dissonance has been calculated.

Dissonance of Chords

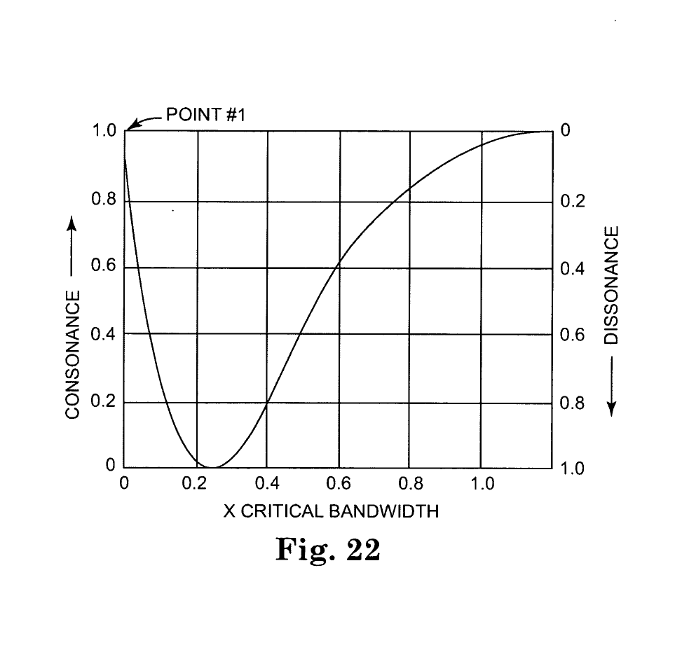

An illustrative method 236 of determining the dissonance between chords will now be described with respect to FIG. 23. The dissonance of chords in a song may correspond to the dissonance between the successive chords of the song. The dissonance descriptor can be represented by a real number within the range [0,1].

The method 236 takes as an input (block 238) the sequence of chords of a song or an audio piece, which can be calculated in a manner described above. In order to calculate the dissonance of successive chords, it can be assumed that the dissonance of two successive chords is substantially the same as the dissonance of two chords played simultaneously. Accordingly, and as shown generally at block 240, successive pairs of chords are selected from the chord sequence 238. It can also be assumed that both successive chords have an equal amount of energy, and therefore the energies of the fundamentals of their chords in the method 238 are considered to be 1.

Any chord is composed of a number of fundamental frequencies, f₀ plus their harmonics, which are multiples of the fundamentals, n·f₀ with n=1, 2, 3 . . . , and so forth. The dissonance between two simultaneous chords is therefore the dissonance produced by the superimposed fundamentals of every chord and their harmonics. However, since the number of fundamentals may vary and the number of harmonics per fundamental is theoretically infinite, it may be necessary for computational reasons to limit the number of fundamentals and harmonics. In certain embodiments, the number of fundamentals taken per chord is 3 since the three most representative fundamentals of a chord are generally sufficient to characterize the chord. In a similar manner, 10 harmonics, including the fundamental, can also be considered sufficient to characterize the chord.

Also, in order to take into consideration the attenuation of the harmonics of the fundamentals, the amplitude of the subsequent harmonics can be multiplied by a factor such as 0.9. Thus, if F₀ is the amplitude of the fundamental f₀, then the amplitude of the first harmonic 2·f₀ would be 0.9*F₀. The amplitude of the second harmonic 3·f₀ would be (0.9)²·F₀, and so forth for the subsequent harmonics.

Once all the fundamentals and their associated harmonics of both chords have been calculated, a spectrum comprising 60 frequencies can be obtained (block 242). The 60 frequencies may correspond, for example, to the six fundamentals and their 54 harmonics, 9 per fundamental.

The dissonance of this spectrum can then be calculated the same way as if it was a frame in the aforementioned method 216 for calculating the dissonance of a song or audio piece. Thus, the spectrum can be weighted to take into consideration the difference in perception of the human ear for different frequencies. The local maxima can then be extracted and the dissonance of the spectrum calculated (block 244).

Once the dissonance of the spectrum is calculated for two consecutive chords, the process can then be repeated advancing by one in the sequence of chords of a song or audio piece (block 246). Thus, if a song is composed of n chords, at the end of the processing of the complete song, a sequence of n−1 dissonances is obtained. The average of the sequence of dissonances is then computed (block 248) in order to obtain the dissonance of chords of the song or audio piece (block 250).

Spectral Complexity

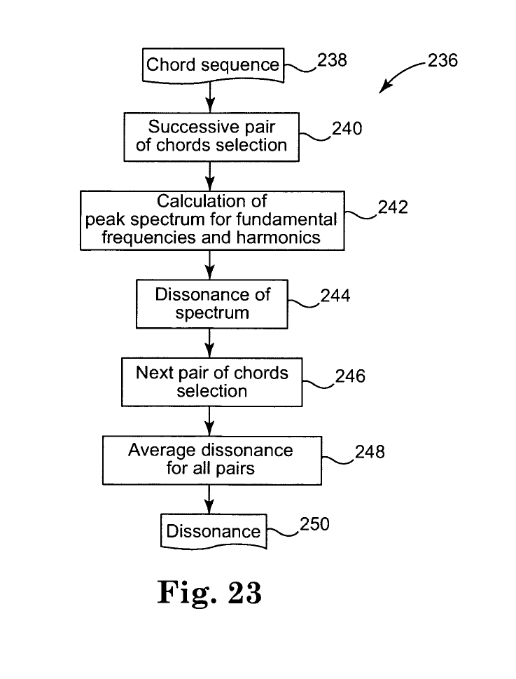

In certain embodiments, and as further shown with respect to FIG. 24, the spectral complexity may also be calculated as a step or steps used in determining the dissonance of a song or audio piece, or in determining the dissonance between chords, as discussed above. The spectral complexity can be understood generally as a measure of the complexity of the instrumentation of the audio piece. Typically, several instruments are present in an audio piece. The presence of multiple instruments increases the complexity of the spectrum of the audio piece and, as such, can represent a useful audio feature for characterizing the audio piece. The spectral complexity descriptor is a real number representing this complexity.

As shown in FIG. 24, an illustrative method 252 for determining the spectral complexity of an audio piece can begin at block 254 with the step of extracting spectral peaks from the audio piece. The maxima can be extracted from each audio frame in a manner similar to that discussed above, by removing any spectral peaks below a certain threshold (block 256), and then counting those spectral peaks that are above the threshold (block 258). In general, the chosen threshold should not be too low since, in such case, the spectral peaks that do not belong to the audio piece but rather to noise would be counted. Conversely, if the threshold chosen is too high, there is the risk that some important spectral peaks that do belong to the audio piece may be missed. In certain embodiments, a value of 0.005 can be used to provide a proper count of the peaks while avoiding noise.

Once a count of the spectral peaks is determined (block 258), the number of peaks per frame can then be averaged (block 260), thus obtaining a value of the spectral complexity of the audio piece (block 262).

### Rhythm Descriptors

Onset Rate

The onset of an audio piece is the beginning of a note or a sound in which the amplitude of the sound rises from zero to an initial peak. The onset rate, in turn, is a real number representing the number of onsets per second. It may also be considered as a measure of the number of sonic events per second, and is thus a rhythmic indicator of the audio piece. A higher onset rate typically means that the audio piece has a higher rhythmic density.

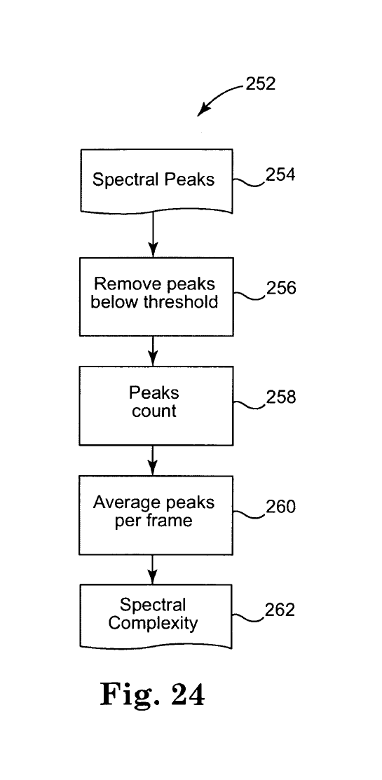

FIG. 25 is a flow chart showing an illustrative method 264 of determining the onset rate of an audio piece 266. First, the audio piece 266 can be divided into overlapping frames via a windowing process (block 268). Each frame, for example, may have a size of 1024 samples and an overlap of 512 samples, corresponding to a frame length of around 20 ms. If a different frame length is selected, then either the number of samples per frame must also be changed or the sampling rate must be changed. The number of samples can be linked to the sampling rate by correlating 1 second to 44,100 samples.

Then, each frame can be smoothed down to get rid of noisy frequencies. To accomplish this, each frame can be modulated with a window function (block 270). In certain embodiments, for example, this window function is a discrete probability mass function such as a Hann function, although other window functions such as any low-resolution window function may be used.

Next, a frequency quantization of each windowed frame can be performed (block 272). In certain embodiments, such quantization can include the use of a Fast Fourier Transform (FFT). After the quantization a vector containing the frequencies with the corresponding energies can be obtained.

Then, an onset function detection can be calculated. An onset detection function is a function that converts the signal or its spectrum into a function that is more effective in detecting onset transients. However, most onset detection functions known in the art are better adapted to detect a special kind of onset. Therefore, in the present invention two different onset detection functions are used. The first onset detection function is the High Frequency Content (HFC) function (block 274), which is better adapted to detect percussive onsets while being less precise for tonal onsets. The onsets can be found by adding the weighted energy in the bins of the FFT, wherein the weighting factor is the position of the bin in the frame based on the following equation:

$$HFC = {\sum }_{i = 0}^{N - 1} i \cdot \vert {X}_{i} ( n ) \vert \qquad ( 30 )$$

Thus, high frequencies have a larger weight whereas low frequencies have a lesser weight. This calculation is carried out for each frame in the FFT of the audio piece 266.

The second onset function is the Complex Domain function (block 276), which is better adapted to detect tonal onsets while being less precise for percussive onsets. The Complex Domain function determines the onsets by calculating the difference in phase between the current frame and a prediction for the current frame that does not comprise an offset. An example of such process is described, for example, in “Complex Domain Onset Detection For Musical Signals” by Duxbury et al., published in “Proc. Of the 6^{th} Int. Conference on Digital Audio Effects (2003),” which is incorporated herein by reference in its entirety. This calculation is also carried out for each frame in the FFT of the audio piece 266.

Then, both detection functions are normalized (blocks 278,280) by dividing each of their values by the maximum value of the corresponding function. In order to reduce the two different offset functions into a single onset detection function, the two detection functions are summed by their respective values (block 282). The resulting onset detection function is then smoothed down by applying a moving average filter (block 284) that reduces or eliminates any eventual spurious peak.

The onsets can then be selected independently of the context. To accomplish this, each onset detection function value is compared to a dynamic threshold. This threshold is calculated for each frame, and its calculation is carried out by taking into consideration values of the onset detection function for preceding frames as well as subsequent frames. This calculation takes advantage of the fact that in the sustained period of a sound the only difference of a frame with the next one is the phase of the harmonics, provided there is not any onset in the subsequent frames. Using this phase difference, it is therefore possible to predict the values in the subsequent frames.

The threshold may be calculated (block 286) as the median of a determined number of values of the onset detection function samples, where the selected values of the onset detection function comprise a determined number of values corresponding to frames before the frame that is being considered, and a number of values corresponding to frames following the frame that is being considered. In certain embodiments, the number of values of frames preceding the current frame being considered is 5. In other embodiments, the number of values of frames following the current frame is 4. The foreseen value for the current frame may also be taken into account.

Once a threshold is calculated (block 286), an onset binary function is then defined (block 288) that yields the potential offsets by assigning a value of 1 to the function if there is a local maximum in the frame higher than the threshold. If there are no local maxima higher than the threshold, the function yields a value of 0. A value of 1 for a determined frame indicates that this frame potentially comprises a potential audio onset. Thus, the results of this function are concatenated and may be considered as a string of bits.

Since the chosen length of the frames is very small (i.e., around 20 ms), it is necessary to clean the results of the function to obtain the actual number of onsets in the audio piece (block 290). To accomplish this, the frames that have an assigned value of 1 but whose preceding and subsequent frame have an assigned value of 0 are assumed to be a false positive. For example, if the part of the bit string is 010 it is changed to 000, it is assumed that the frame is a false positive. On the other hand, successive frames of potential audio onsets are summed up into a single onset. For example, a bit string of 0011110 would be changed into 0010000. After cleaning the bit string, the obtained result is a bit string with a number of 1 corresponding to the number of onsets in the audio piece 266.

The onset rate can then be calculated (block 292) by dividing the number of onsets in the audio piece 266 by the length of the audio piece 266 in seconds.

Beats Per Minute (BPM)

The beat of an audio piece is a metrical or rhythm stress in music. In other words, the beat is every tick on a metronome that indicates the rhythm of a song. The BPM is a real positive number representing the most frequently observed tempo period of the audio piece in beats per minute.

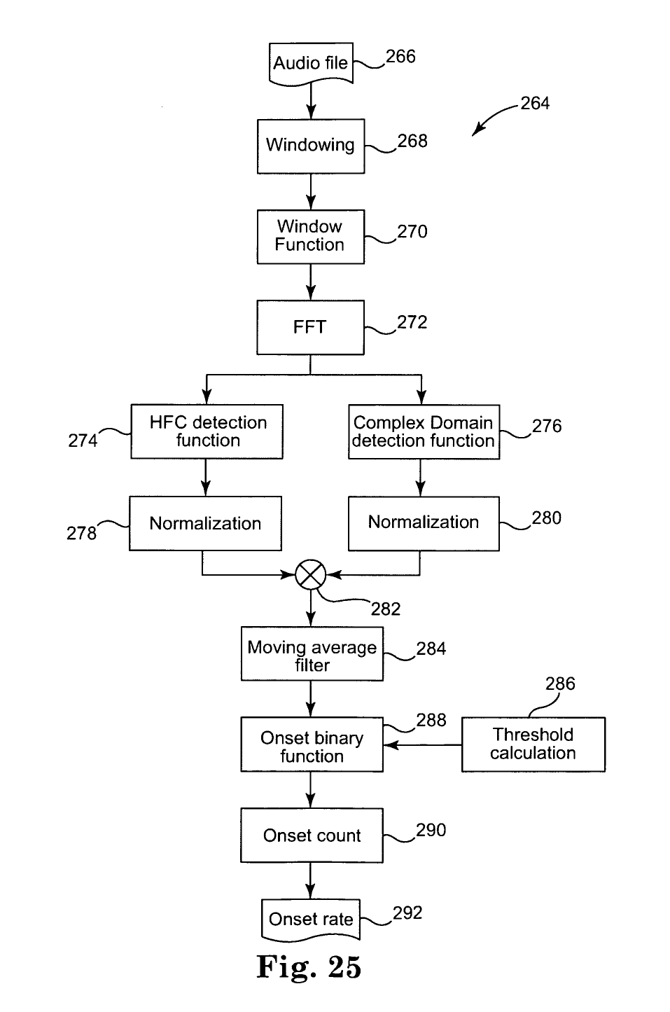

FIG. 26 is a flow chart showing an illustrative method 294 of determining the beats per minute (BPM) of an audio piece 296. The method 294 may begin by reproducing the above steps for onset detection until the frequency quantization is obtained. For example, the audio piece 296 can be divided into overlapping frames via a windowing process (block 298). Each frame can then be modulated with a window function (block 300) in order to remove or eliminate noise frequencies. A frequency quantization of each windowed frame can then be performed (block 302).

Once a frequency quantization is performed, the spectrum may then be divided (block 304) into several different frequency bands. In some embodiments, for example, the spectrum may be divided into 8 different bands having boundaries at 40.0 Hz, 413.16 Hz, 974.51 Hz, 1,818.94 Hz, 3,089.19 Hz, 5,000.0 Hz, 7,874.4 Hz, 12,198.29 Hz, and 17,181.13 Hz. The energy of every band is then computed. Also, in order to emphasize frames containing note attacks in the input signals, positive variations of the per-band energy derivatives are extracted (block 306).

For the purpose of emphasizing the rhythmic content of the audio signal, two onset detection functions (308) are also calculated. The two onset detection functions (308) are the High Frequency Content (HFC) function and the Complex-Domain function, as discussed previously. The 8 band energy derivatives (block 306) and the two onset detection functions (block 308) are referred to herein as feature functions since the process for all of them is the same.

Next, each of the 8 band energy derivatives (306) and the two onset detection functions (block 308) are resampled (block 310) by taking a sample every 256 samples. The resampled feature functions are then fed to a tempo detection module, which forms a 6 second window with each of the resampled feature functions and calculates (block 312) a temporal unbiased autocorrelation function (ACF) over the window based on the following formula:

$${r}_{feat} [ l ] = {( ( {\sum }_{n = 0}^{N - 1} feat [ n ] \cdot feat [ n - l ] ) \cdot ( 1 + \vert ( l - N ) \vert ) )}^{2} \qquad ( 31 )$$

where:

feat[n] is the feature function that is currently being processed; and

N is the length of the feature function frame.

From the ACF, it is possible to estimate the tempo by selecting the lag of a particular peak. However, in order to improve accuracy of the tempo estimation it is necessary to observe the lag of more than a single peak. The lags observed should be related with the first lag corresponding to a fundamental frequency and the rest of the n-observed lags to its n first harmonics. In certain embodiments, the number of peaks observed is 4.

Thus, in order to find four lags, the ACF is passed through a comb filter bank (block 314), producing a tempo (block 316). Each filter in the bank corresponds to a different fundamental beat period. Also, in order to avoid detecting tempi that are too low, the comb filter bank is not equally weighted but uses a Rayleigh weighting function with a maximum around 110 bpm. This is also useful to minimize the weight of tempi below 40 bpm and above 210 bpm. The tempo is then computed (block 318). The filter that gives a maximum output corresponds to the best matching tempo period.

Also, a tempo module calculates the beats positions by determining the phase, which can be calculated (block 320) by correlating the feature function with an impulse train having the same period as the tempo (block 316) that was found in the previous step. The value that maximizes the correlation corresponds to the phase of the signal. However, since this value may be greater than the tempo period, the phase is determined (block 322) by taking the value modulo of the tempo period determined before. The phase determines the shifting between the beginning of the window and the first beat position. The rest of the beat positions are found periodically, by a tempo period, after the first beat.

This process is repeated for each of the function features for each frame. The most frequently observed tempo across all function features is selected as the tempo period for this frame. The same process is applied to the phase detection across all function features.

Once the tempo period of the current frame for each of the 10 features is obtained, the 6 second window is slid of 512 feature samples and its tempo computed again. Thus, the 6 second window constitutes a sliding window with a hop size of 512. These numbers may be modified but a 6 second window is generally necessary to detect slow tempi audio pieces.

A sequence of tempi and a sequence of phases can then be obtained from all the calculations across the whole song of the sliding window. The tempo period of the song is then selected as the most frequently observed tempo in the sequence. The same process is applied to obtain the phase.

Finally, it is possible to obtain the beats per minute from the tempo period based on the following relationship:

$$bpm = \frac{60 \cdot sampleRate}{tempo \cdot hopSize} \qquad ( 32 )$$

If desired, the selected phase can also be used to calculate the beats position.

Beats Loudness

Beats loudness is a measure of the strength of the rhythmic beats of an audio piece. The beats loudness is a real number between 0 and 1, where a value close to 0 indicates that the audio piece has a low beats loudness, and a value close to 1 indicates that the audio piece has a high beats loudness.

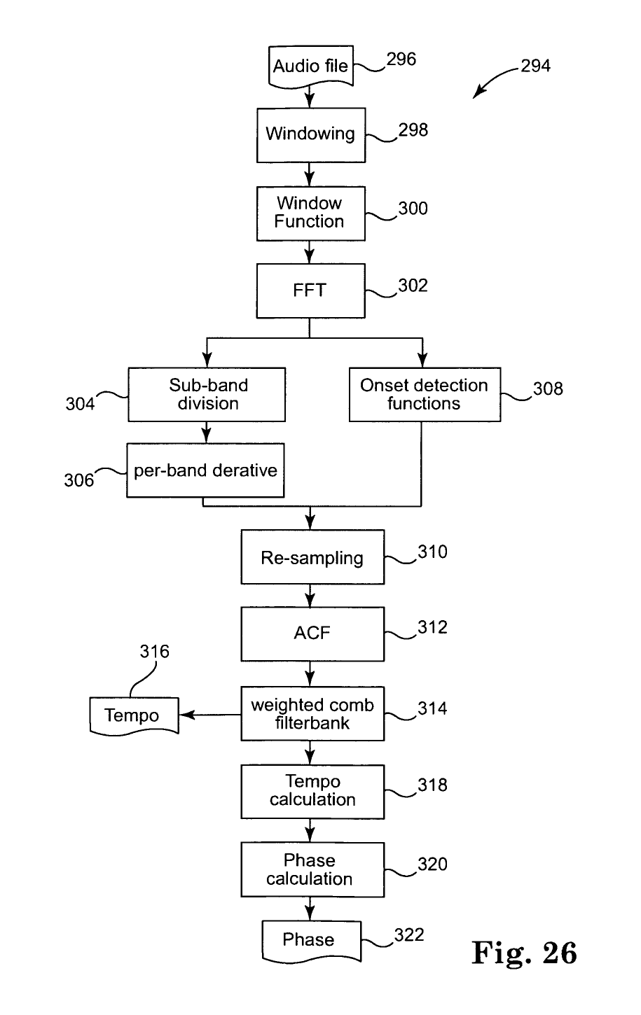

FIG. 27 is a flow chart showing an illustrative method 324 for calculating the beats loudness and/or bass beats loudness of an audio piece. The method 324 may begin generally at block 326 by receiving an audio piece having the format described above with respect to FIG. 26 in which the beats position has been determined. The steps described hereafter, although described for a single beat, can be applied to every beat in the audio piece.

First, the beat attack position in the audio piece is determined (block 328). The beat attack position of a beat is the position in time of the point of maximum energy of the signal during a beat. Thus, there is only one beat attack position per beat. It is necessary to finely determine the beat attack position because the precision of the method 324 is very sensitive to the precision in the position of the beat attack.

In order to determine the beat attack position of the audio piece, a frame covering a 100 ms window centered on the beat position is taken. Then, the beat attack position is determined by finding what is the point of highest energy in the range. To accomplish this, the index i that maximizes the relation frame(i)*frame(i) is determined, where frame(i) is the value of the sample in the frame at the index i.

Once the beat attack position is determined, a frame starting from the beat attack position can be taken from the audio piece. The size (in milliseconds) of the frame may be taken arbitrarily. However, the frame should represent an audio beat from the beat attack to the beat decrease. In certain embodiments, the size of the frame may be 50 ms.

Next, the frame can be smoothed down to get rid of noisy frequencies. For that purpose, the frame can be modulated with a window function (block 330). In certain embodiments, this window function is a Blackman-Harris-62 dB function, but other window functions such as any low-resolution window function may be used. Then, a frequency quantization (block 332) of the windowed frame is performed (e.g., using a Fast Fourier Transform). After the frequency quantization, a vector containing the frequencies with the corresponding energies is then obtained.

The total energy of the beat is then calculated (block 334) by adding the square of the value of every bin in the vector obtained from the frequency quantization. The resulting energy represents the energy of the beat, therefore the higher the energy of the frame spectrum, the louder is the beat.

The above steps can be performed for each beat in the audio piece. Once all the beats have been analyzed, the energy of the frames each corresponding to one beat in the audio piece is averaged (block 336). The averaged result is between 0 and 1 because the window function applied to each frame is already normalized. Therefore, the total energy of each frame, and thus their average is also between 0 and 1. The averaged energy of the frames constitutes the beat loudness (block 338).

Bass Beats Loudness

The above described method 326 may also be used for deriving the bass beats loudness. The bass beats loudness is a measure of the weight of low frequencies in the whole spectrum within the beats of the audio piece. It is a real number between 0 and 1.

The calculation process of the bass beats loudness is generally the same as for calculating the beats loudness, but further includes the step of calculating the ratio between the energy of the low frequencies and the total energy of the spectrum (block 340). This can be calculated on a frame-by-frame basis or over all frames. For example, the beat energy band ratio can be determined by calculating the average energy in the low frequencies of the frames and dividing it by the average total energy of the frames.

The range of low frequencies can be between about 20-150 Hz, which corresponds to the bass frequency used in many commercial high-fidelity system equalizers. Other low frequency range values could be chosen, however.

The above steps can be performed for each beat in the audio piece. Once all of the beats have been analyzed, the energy of the frames each corresponding to one bass beat is averaged (block 342). The averaged result is between 0 and 1 because the window function applied to each frame is already normalized. Therefore, the total energy of each frame, and thus their average is also between 0 and 1. The averaged energy of the frames constitutes the bass beats loudness (block 344).

The combination of both the beats loudness and the bass beats loudness may be useful for characterizing an audio piece. For example, a folk song may have a low beats loudness and a low beats bass beats loudness, a punk-rock song may have a high beats loudness and a low bass beats loudness, and a hip-hop song may have a high beats loudness and a high bass beats loudness.

Rhythmic Intensity

Rhythmic intensity is a measure of the intensity of an audio piece from a rhythmic point of view. Typically, a slow, soft and relaxing audio piece can be considered to have a low rhythmic intensity. On the other hand, a fast, energetic audio piece can be considered to have a high rhythmic intensity. The rhythmic intensity is a number between 0 and 1 where higher values indicate a more rhythmically intensive audio piece.

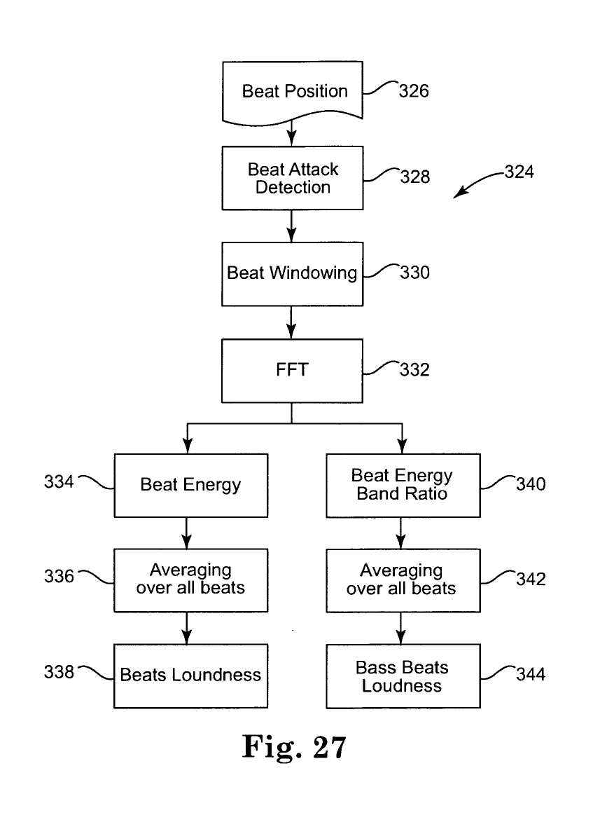

FIG. 28 is a flow chart showing an illustrative method 346 of computing a rhythmic intensity descriptor. As shown in FIG. 28, the rhythmic intensity descriptor can be based on the onset rate (block 348), the beats per minute (block 350), the beats loudness (block 352), and the bass beats loudness (block 354). As discussed herein, each of these descriptors represent a number within a range. Typically, the chosen range depends on the descriptor that is being considered.

The rhythmic intensity can be calculated by splitting each of the ranges into three different zones. The choices of the zones for each descriptor can be made according to a double criteria taking as one criteria the statistical analysis of the descriptors of a sample of music pieces that is large enough to be representative (e.g. around one million). Musicological concepts can also be utilized as another criteria. The threshold values correspond to the limits that human perception presents. For example, it is known that the higher threshold for the perception of a slow rhythm is around 100 bpm while the lower limit for a fast rhythm is around 120 bpm. Audio pieces with a bpm between 100 and 120 are considered to be neither fast nor slow. A similar rationale can be followed to choose the zones for the other descriptors.

In some embodiments, the zones for each of the descriptors can be defined as shown in the following table:

Table of Descriptors And Corresponding Zones

| Descriptor | Zone 1 | Zone 2 | Zone 3 |
|---|---|---|---|
| Beats Per Minute | 0.0 to | 100.0 to 120.0 | 120.0 and more |
| | 100.0 | | |
| Onset Rate | 0.0 to 3.0 | 3.0 to 5.0 | 5.0 and more |
| Beats Loudness | 0.0 to 0.1 | 0.1 to 0.2 | 0.2 to 1.0 |
| Bass Beats Loudness | 0.0 to 0.2 | 0.2 to 0.4 | 0.4 to 1.0 |

Once the ranges corresponding to each descriptor are defined, the rhythmic intensity can be calculated by assigning a score (blocks 356,358,360,362) depending on which zone the value of the corresponding descriptor falls in. Thus, if the value of any given corresponding descriptors (e.g., beats per minute or onset rate) falls within the range assigned to zone 1, this indicates that the descriptors contributes with 1 to rhythmic intensity. If the value falls within the range assigned to zone 2, then it contributes with 2. If the value falls within the range assigned to zone 3, then it contributes with 3. This process is carried out for each of the onset rate, beats per minute, beats loudness, and bass beats loudness descriptors corresponding to the audio piece.

When all four descriptors have been considered, the sum of the contributions of every descriptor is calculated (block 364) and normalized (block 366). Since the normalized value is between 0 and 1, the normalization is performed by subtracting the minimum score possible of 4 and dividing the obtained score by the maximum score−minimum score, which is 12−4=8. This can be understood from the following equation:

$$RhythmicIntensity = \frac{obtainedScore}{max Score - min Score} = \frac{obtainedScore}{8} \qquad ( 34 )$$

Thus, the final value of the rhythmic intensity (block 368) is between 0 and 1.

### Spatial Descriptors

Panning

Panning of an audio piece is generally the spread of a monaural audio signal in a multi-channel sound field. A panning descriptor containing the spatial distribution of audio mixtures within polyphonic audio can be used to classify an audio piece. In some embodiments, for example, the extraction of spatial information from an audio piece can be used to perform music genre dassification.

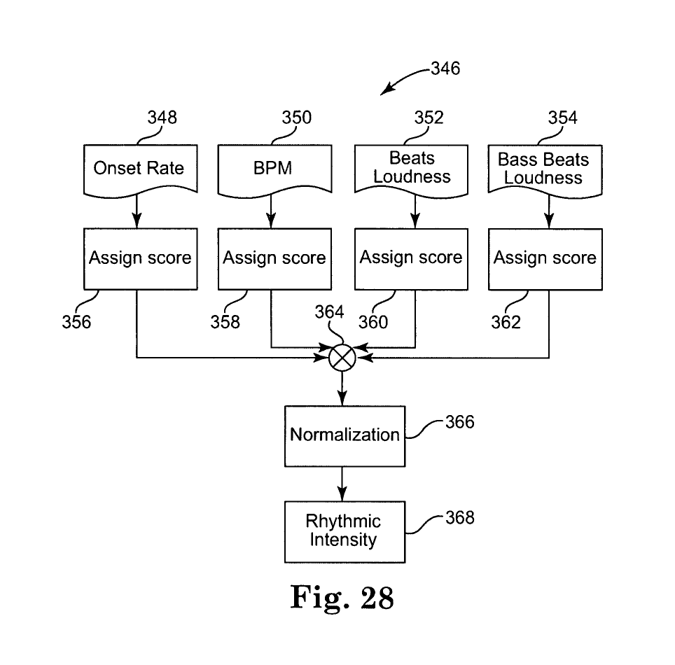

FIG. 29 is a block diagram of an illustrative audio dassification system 370 for combining spectral features with spatial features within an audio piece. As shown in FIG. 24, audio classification system 370 includes an audio database 372 that contains the audio pieces that are to be classified. An audio piece is provided to a spectral features module 374 that extracts a vector of features z_{Q} from the audio piece, mixing left and right audio channels. In parallel, the audio piece with separated left and right channels ChL,ChR is also provided to a spatial features module 376 that extracts panning coefficients p_{L} from the audio piece. The spectral features z_{Q} and the panning coefficients p_{L} are then provided to an audio classifier module 378. The audio classifier module 378 can be previously trained by means of machine learning techniques using a number of audio pieces as examples. These example audio pieces contain both the features (spectral and spatial) and the class associated with each example. After the training phase, the audio classifier module 378 is able to predict the class 380 associated with new audio pieces not used in the training phase.

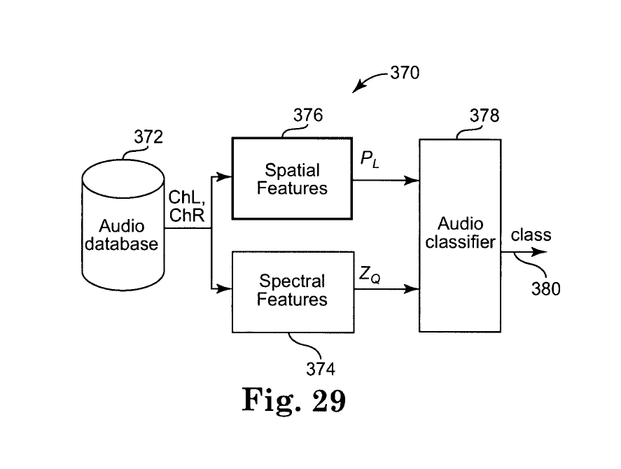

FIG. 30 is a flow chart showing an illustrative method 382 of extracting the panning coefficients p_{L} from an audio piece using the audio classification system 370. The audio piece may comprise a multi-channel audio piece having a left channel ChL(t) and a right channel ChR(t). In some embodiments, the audio piece may be in a PCM format with a sample rate of 44,100 Hz and 16 bits per sample.

The method 382 can be performed on a frame by frame basis, where each frame corresponds to a short-time window of the audio piece such as several milliseconds. The stereo mix of an audio piece can be represented as a linear combination of n monophonic sound sources:

$$[ \begin{matrix}{out}_{L} [ k ] \\ {out}_{R} [ k ]\end{matrix} ] = [ \begin{matrix}{α}_{1}^{L} [ k ] … {α}_{n}^{L} [ k ] \\ {α}_{1}^{R} [ k ] … {α}_{n}^{R} [ k ]\end{matrix} ] \cdot [ \begin{matrix}i {n}_{1} [ k ] \\ ⋮ \\ i {n}_{n} [ k ]\end{matrix} ] \qquad ( 35 )$$

Also, the panning knob in mixing consoles or digital audio workstations follows the following law which constitutes the typical panning formula, wherein x ε [0,1] for mixing a sound source i:

αᵢ^{L}Cos(x·π/2) (36)

αᵢ^{R}=sin(x·π/2) (37)

As indicated generally at block 384, a short-time Fourier transformation (STFT) for each of the audio channels ChL(t),ChR(t) is performed. Then, ratios R[k] are derived from the typical panning formula above (block 386), referring to an azimuth angle range going from −45° to +45°, and the ratio of the magnitudes of both spectra S_{L}(t,f),S_{R}(t,f). The resulting sequence R[k] represents the spatial localization of each frequency bin k of the STFT. The range of the azimuth angle of the panorama is Az ε [−45°,45°], while the range of the ratios sequence value is R[k]ε[0,1]. R[k] can thus be expressed as:

$$R [ k ] = \frac{2}{π} arc tan ( \vert \frac{{S}_{L} [ k ]}{{S}_{R} [ k ]} \vert ) \qquad ( 38 )$$

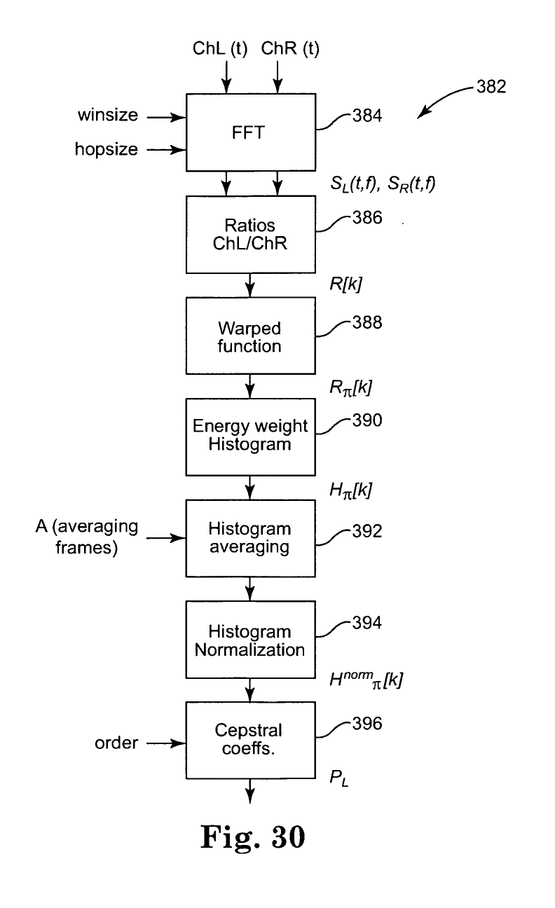

At block 388, the effect of the direction of reception of acoustic signals in auditory perception is taken into consideration using a warping function. Since human auditory perception presents a higher resolution towards the center of the azimuth, a non-linear function such as the one depicted in FIG. 31 is used. A warping function is applied to the azimuth angle in order to have more resolution in the median (Az=0°). The function f(x) is defined with the mapping of variables being x ε [0,1]←→Az ε [−45°,45°]:

R_{W}[k]=f(R[k]) (39)

f(x)=−0.5+2.5x−x², x≧0.5

f(x)=1−(−0.5+2.5(1−x)−(1−x)², x<0.5 (40)

Once the warped ratios sequence is obtained, an energy weight histogram H_{w} is calculated (block 390) by weighting each bin k with the energy of a frequency bin of the STFT, where S_{L}[k]=S_{L}(t,fₖ). This can be understood in the following equation, where M is the number of bins of the histogram H_{w} and N is the size of the spectrum which corresponds to half of the STFT size:

$${i}_{k} = floor ( M \cdot {R}_{W} [ k ] ) \\ {H}_{w} ( {i}_{k} ) = {\sum }_{k = 0}^{N} \vert {S}_{L} [ k ] + {S}_{R} [ k ] \vert \qquad ( 41 )$$

At block 392, the computed histograms are then averaged together. Since panning histograms can vary very rapidly from one frame to the next, the histograms may be averaged over a time window of several frames which can range from hundreds of milliseconds to several seconds. If a single panning histogram for the whole song is required, the averaging time should correspond to the song length. The minimum value of time for averaging purposes is the frame length which is determined by the input in the STFT algorithm. In one embodiment, the minimum value of time for averaging is around 2 seconds, although other averaging times greater or lesser than this are possible. For the averaging, a running average filter such as the one in equation (42) below for each of the M bins of the histogram Ĥ_{w,n} is used, where A is the number of averaging frames, and n indicates the current frame index:

$${\hat{H}}_{w} [ m , n ] = \frac{1}{A} {\sum }_{k = 0}^{A - 1} {H}_{w} [ m , n - k ] \qquad ( 42 )$$

Then, as indicated generally at block 394, the histogram Ĥ_{w} is normalized to produce an averaged histogram that is independent of the energy in the audio signal. This energy is represented by the magnitude of S_{L}(t,f),S_{R}(t,f). The histogram Ĥ_{w} can be normalized by dividing every element m in the histogram by the sum of all bins in the histogram as expressed in the following equation:

$${\hat{H}}_{w}^{norm} [ m ] = \frac{{\hat{H}}_{w} [ m ]}{{\sum }_{h = 0}^{M} {\hat{H}}_{w} [ h ]} \qquad ( 43 )$$

Finally, as indicated at, block 396, the normalized panning histogram Ĥ_{w}^{norm} is converted to the final panning coefficients pₗ using a cepstral analysis process. The logarithm of the panning histogram Ĥ_{w}^{norm} may be taken before applying an Inverse Discrete Fourier Transform (IDFT). The following equation shows how the input coefficients of the IDFT E_{H}[m] are generated, where the size of E_{H}[m] is 2M, and the coefficients are symmetric:

$${E}_{H} [ m ] = \{ \begin{matrix}{\hat{H}}_{w}^{norm} [ m ] & 0 \leq m < M - 1 \\ {\hat{H}}_{w}^{norm} [ 2 M - m - 1 ] & M \leq m < 2 M - 1\end{matrix} \qquad ( 44 )$$

The panning coefficients pₗ are calculated by taking the real part of the L first coefficients of the IDFT output. A good trade-off between azimuth resolution and the size of the panning coefficients can be achieved with L=20.

Once the panning coefficients pₗ are obtained, a generic classification algorithm not necessarily adapted to audio classification may be used. The generic classification algorithm could be based on neural networks or any other suitable classification system. A support vector machines method may also be used for the classification.

Even though the method 382 has been described for all frequency bins k, it can also be applied to different frequency bands. The method 382 can be repeated from block 386 on a subset of the ratios vector R[k], from k ε [Bᵢ,Eᵢ] where Bᵢ is the beginning bin of one band, and Eᵢ is the ending bin of the band. By using a multi-band process, it is possible to achieve greater detail in the information about localization of sound sources of different nature.

While the computation of the panning coefficients pₗ from two audio channels has been described with respect to stereo recordings having a left channel (ChL) and a right (ChR), the method 382 could also be used extract information from other audio channels or combinations of audio channels. In some embodiments, for example, surround-sound audio mixtures could also be analyzed by taking pairs of channels such as front/left and back/left channels. Alternatively, and in other embodiments, the panning distribution between four or more channels can be used. Instead of calculating the ratios between a left and a right channel, however, a ratio between each pair of channels is calculated. This yields one R[k] vector for each pair of channels in the step shown at block 386, with the remainder of the method 382 applied in the manner described above. In such case, one vector of panning coefficients pₗ for each pair of channels would be obtained. For audio classification, all vectors of panning coefficients would be combined.

Alternatively, and in other embodiments, the panning coefficients p₁ may be combined in an algorithm based on the Bayesian Information Criterion (BIC) to detect homogeneous parts of an audio mixture to produce a segmentation of the audio piece. This may be useful, for example, to identify the presence of a soloist in a song.

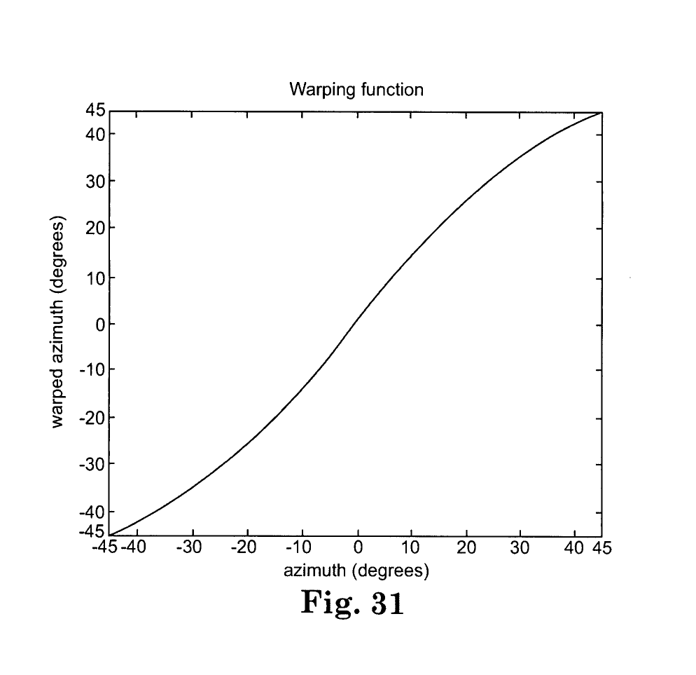

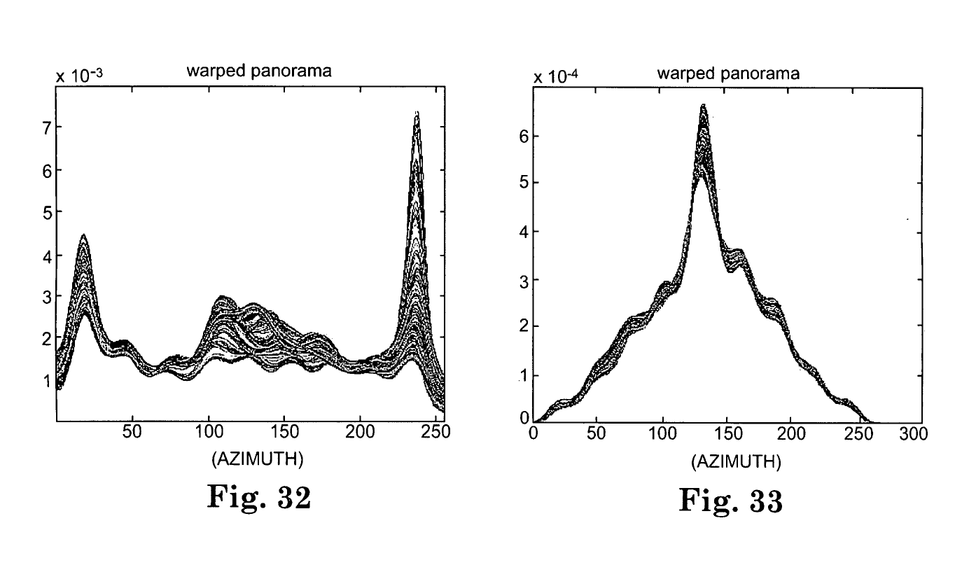

The results of the method 382 will be explained in accordance with FIGS. 32 and 33. FIGS. 32 and 33 represent illustrative panning coefficients for two different musical genres. FIG. 32 represents, for example, the panning coefficients for a song belonging to the Jazz genre and FIG. 33 represents the panning coefficients for a song belonging to the Pop-Rock genre. For comparison purposes the configuration parameters chosen were audioWindowSize=8192 samples, framerate=21.5 ms, M=512 histogram bins, IFFTsize=1024, averagingTime=2 seconds and the number of panning coefficients L=20.

Both FIGS. 32 and 33 illustrate the envelopes corresponding to the Fourier Transform of the panning coefficients, computed as env=FFT(pₗ), applying zero-padding to the panning coefficients. The figure were obtained using a warping angle function. Different curves in the same figure correspond to different frames of the song.

In a comparison of both figures it can be observed that for a Jazz song, such as in FIG. 32, the spatial distribution of the energy presents several peaks in the azimuth axis. This is due to the typical mixing techniques used in jazz productions. In contrast to that, it is clear in FIG. 33 that for a pop-rock song, the spatial distribution of the energy is concentrated in the center of the azimuth producing a triangular shape which is the general trend in many pop-rock stereo productions.

### Similarity

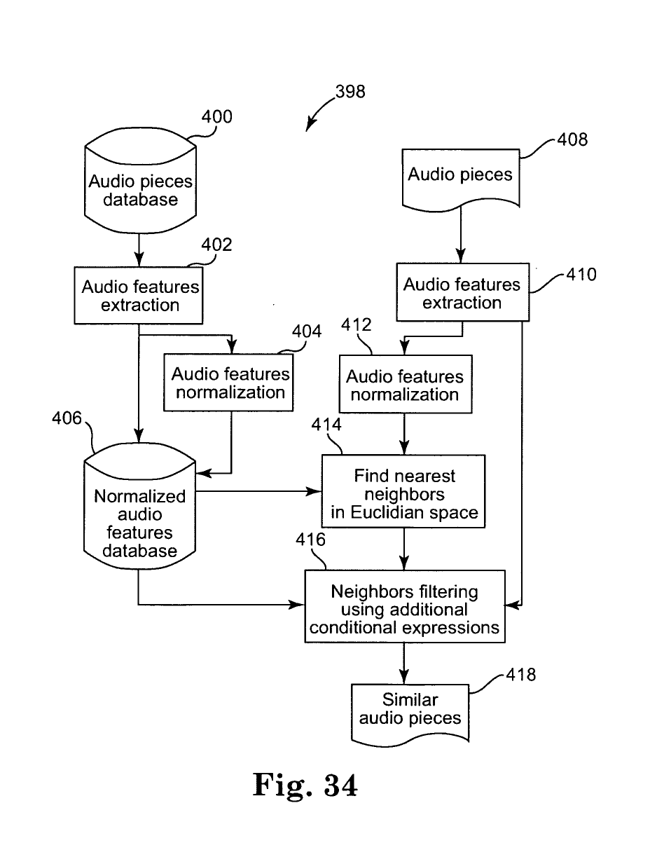

FIG. 34 is a flow chart showing another illustrative method 398 for determining musical similarity between audio pieces. Prior to calculating similarity between different audio pieces, it may be necessary to compute and store one or more of the above-mentioned descriptor features for a database of audio pieces (block 400). Example descriptor features that can be extracted from the database may include, for example, tonal descriptors, dissonance or consonance descriptors, rhythm descriptors, and/or spatial descriptors, as discussed herein. In certain embodiments, the descriptor features can be stored in a reference database (block 400). Since only those audio pieces that were processed already can be used in the similarity calculation, the number of audio pieces should typically be as large as possible.

Once the audio features are calculated (block 402) for all the audio pieces in the reference database (block 400), the values for each extracted feature is normalized (block 404) so that all values are between 0 and 1. The normalized values are also stored in the reference database (block 406) along with the non-normalized values. Thus, each audio piece has two vectors of features associated with it, where one vector contains the values for the audio features and the other vector contains the normalized values for each audio feature. Each feature represents a dimension in an n-dimensional space.

As further shown in FIG. 34, one or more audio features from an audio piece (block 408) to be compared against the audio pieces contained in the database (block 400) can be extracted and stored in a vector (block 410). The audio piece may comprise, for example, a cover version of a song to be compared against a database of audio pieces containing the original song version. Once the features are extracted (block 410), they are normalized (block 412) so that all features are between 0 and 1. The normalized vector is then stored as another vector.

As indicated further at block 414, a distance is calculated between the vector containing the normalized values from the audio piece (block 408) and the vectors containing the normalized values from the audio pieces in the reference database (block 400). In some embodiments, for example, the distance is a Euclidean distance, although any other suitable distance calculation may be used. As further indicated generally at block 416, additional filtering can be performed using additional conditional expressions to limit the number of similar audio pieces found (block 418). For example, an additional conditional expression that can be used is an expression limiting the number of closest audio pieces provided as a result. Furthermore, other conditions not related to similarity but to some of the extracted features can also be used to perform additional filtering. For example, a condition may be used to specify the 10 closest audio pieces that have a beats per minute (bpm) of more than 100, thus filtering audio pieces that have a higher rhythmic intensity. Also, it is possible to give different weights to different features. For example, a spectral complexity distance may be assigned a weight twice that of a beats base loudness feature.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What is claimed is:

1. A method for determining similarity between two or more audio pieces, comprising:
extracting one or more descriptors from each of the audio pieces;
generating a vector for each of the audio pieces;
extracting one or more audio features from each of the audio pieces and storing the features in a database;
calculating values for each audio feature;
normalizing the values for each audio feature;
calculating a distance between a vector containing the normalized values and the vectors containing the audio pieces; and
outputting a result to a user or process.

2. The method of claim 1, wherein the descriptors include one or more dissonance descriptors, tonal descriptors, rhythm descriptors, and/or spatial descriptors.

3. The method of claim 2, wherein the dissonance descriptors include an audio piece dissonance descriptor, a dissonance of chords descriptor, and/or a spectral complexity descriptor.

4. The method of claim 3, wherein, in extracting an audio piece dissonance descriptor from each audio piece, the method includes:
dividing a digitized audio piece into overlapping window frames;
eliminating or reducing noisy frequencies within the window frames;
performing a frequency quantization of each windowed frame and acquiring a vector;
weighting the vector;
extracting local spectral maximums for each frame;
computing a dissonance value based on extracted spectral maximum pairs; and
averaging the dissonances of all window frames to obtain the dissonance of the audio piece.

5. The method of claim 4, wherein a spectral complexity is computed as a step or steps used in determining the dissonance of the audio piece.

6. The method of claim 3, wherein, in extracting a dissonance of chords descriptor from each audio piece, the method includes:
determining the fundamentals and associated harmonics of two chords in an audio piece;
obtaining a spectrum of the frequencies corresponding to the fundamentals and their harmonics;
computing a dissonance of the spectrum;
weighting the spectrum;
computing the dissonance for two consecutive chords; and
averaging the sequence of dissonances from the two consecutive chords.

7. The method of claim 2, wherein the tonal descriptors include a Harmonic Pitch Class Profile (HPCP) descriptor, a chord detection descriptor, a key detection descriptor, a local tonality detection descriptor, a cover versions detection descriptor, and/or a western music descriptor.

8. The method of claim 7, wherein, in extracting a Harmonic Pitch Class Profile (HPCP) descriptor from each audio piece, the method includes computing an HPCP vector by:
dividing a digitized audio piece into windowed frames;
performing a frequency quantization of each windowed frame and acquiring a vector;
eliminating or reducing noisy frequencies within the windowed frames;
extracting local spectral maximums for each window frame;
determining a global tuning frequency value from the spectral maximums;
filtering one or more bands of spectral peaks;
performing a frequency mapping on the bands and obtaining two HPCP vectors;
weighting the frequency contribution and harmonics within the two HPCP vectors;
normalizing the HPCP vectors; and
adding the two HPCP vectors together and normalizing the resultant HPCP vector.

9. The method of claim 8, wherein filtering one or more bands of spectral peaks includes performing band preset and frequency filtering for a high frequency band of peaks and a low frequency band of peaks.

10. The method of claim 7, wherein, in extracting a chord detection descriptor, a key detection descriptor, and a local tonality detection descriptor for each audio piece, the method includes:
obtaining an HPCP vector;
averaging the HPCP vector over a time period;
extracting a chord corresponding to the averaged HPCP vector by correlating the averaged HPCP vector with a set of tonic triad tonal profiles; and
repeating the obtaining, averaging and extracting steps for successive audio frames in the audio piece to obtain a sequence of chords or an estimated key for the audio piece.

11. The method of claim 7, wherein, in extracting a cover version descriptor from each audio piece, the method includes:
obtaining an HPCP vector over a number of window frames;
normalizing the HPCP vector and obtaining a sequence of HPCP vectors;
storing the sequence of HPCP vectors in an HPCP matrix;
calculating a mean value of the HPCP vectors over all frames or by averaging consecutive HPCP vectors;
calculating a transposition index of two songs;
creating a similarity index and determining a measure of similarity;
calculating a similarity matrix; and
obtaining a local alignment matrix from the similarity matrix.

12. The method of claim 7, wherein, in extracting a western music descriptor from each audio piece, the method includes:
obtaining an HPCP vector over a number of window frames;
obtaining a reference frequency by analyzing the deviation of spectral peaks to a standard frequency;
obtaining a global value by combining frame estimates in a histogram;
extracting a set of local maxima;
calculating an equal tempered deviation;
performing a spectral analysis; and
calculating the dissonance of the audio piece.

13. The method of claim 2, wherein the rhythm descriptors include an onset rate descriptor, a beats per minute descriptor, a beats loudness descriptor, a bass beats loudness descriptor, and/or a rhythmic intensity descriptor.

14. The method of claim 13, wherein, in extracting an onset rate descriptor from each audio piece, the method includes:
dividing a digitized audio piece into overlapping window frames;
eliminating or reducing noisy frequencies within the window frames;
performing a frequency quantization of each window frame and acquiring a vector;
calculating an onset detection function including a high frequency content function and a complex domain function;
normalizing the high frequency content function and complex domain function;
comparing each onset detection function value to a dynamic threshold;
calculating a threshold and defining a binary function;
cleaning the results of the binary function; and
calculating an onset rate for the audio piece.

15. The method of claim 13, wherein, in extracting a beats per minute descriptor from each audio piece, the method includes:
dividing a digitized audio piece into overlapping window frames;
eliminating or reducing noisy frequencies within the window frames;
performing a frequency quantization of each window frame and acquiring a vector;
dividing the spectrum into different bands and computing the energy of each band;
calculating an onset detection function including a high frequency content function and a complex domain function;
resampling the band energy derivatives and onset detection functions;
calculating a temporal unbiased autocorrelation function;
estimating the tempo of the audio piece by selecting the lag of a particular peak;
calculating the beats position by determining phase;
obtaining a tempo period for each of the window frames;
obtaining a sequence of tempi and a sequence of phases; and
obtaining a beats per minute value from the tempo period.

16. The method of claim 13, wherein, in extracting a beats loudness descriptor from each audio piece, the method includes:
determining a beat attack position;
obtaining an audio frame starting from the beat attack position;
eliminating or reducing noisy frequencies within the audio frame;
calculating a total energy of the beat;
repeating the determining, obtaining, eliminating, and calculating steps to obtain each beat in the audio piece; and
averaging the energy of the audio frames each corresponding to one beat in the audio piece to obtain a beat loudness of the audio piece.

17. The method of claim 13, wherein, in extracting a bass beats loudness descriptor from each audio piece, the method includes:
determining a beat attack position;
obtaining an audio frame starting from the beat attack position;
eliminating or reducing noisy frequencies within the frame;
calculating a total energy of the beat;
repeating the determining, obtaining, eliminating, and calculating steps to obtain each beat in the audio piece;
averaging the energy of the frames each corresponding to one beat in the audio piece to obtain a beat loudness; and
calculating a ratio of the energy of the low frequencies in the audio piece to the total energy in the audio piece to obtain a bass beats loudness of the audio piece.

18. The method of claim 13, wherein, in extracting a rhythmic intensity descriptor from each audio piece, the method includes:
calculating a beats per minute descriptor, an onset rate descriptor, a beats loudness descriptor, and a bass beats loudness descriptor from the audio piece;
splitting each descriptor into three different zones;
calculating the rhythmic intensity by assigning a score depending on which zone the value corresponding to the descriptor falls in; and
calculating the sum of the scores for each descriptor and normalizing those values to obtain the rhythmic intensity of the audio piece.

19. The method of claim 2, wherein the spatial descriptors includes a panning descriptor.

20. The method of claim 19, wherein, in extracting a panning descriptor from each audio piece, the method includes:
extracting panning coefficients from the audio piece; and
classifying the audio piece based on the panning coefficients.

21. The method of claim 20, wherein the panning coefficients are extracted from each audio piece by:
performing a frequency quantization of each of a plurality of audio channels within the audio piece;
determining the spatial location of the frequencies;
computing an energy weight histogram;
averaging the energy weight histogram;
normalizing the averaged energy weight histogram; and
converting the normalized histogram into panning coefficients.

22. The method of claim 1, further comprising classifying each of the audio pieces based on the one or more extracted descriptors.

23. A method of detecting cover versions of a song, comprising:
extracting a Harmonic Pitch Class Profile (HPCP) vector from an audio piece;
normalizing the HPCP vector and obtaining a sequence of HPCP vectors;
calculating the mean value of the HPCP vectors over all frames or by averaging consecutive HPCP vectors;
calculating a transposition index of two songs;
creating a similarity index and determining a measure of similarity between the two songs;
calculating a similarity matrix;
obtaining a local alignment matrix from the similarity matrix; and
outputting a result to a user or process indicating the similarity between the two songs.

24. A music processing system, comprising:
an input device for receiving an audio signal containing an audio piece;
a tonality analysis module configured to extract tonal features from the audio signal;
a data storing device adapted to store the extracted tonal features;
a tonality comparison device configured to compare the extracted tonal features from the audio signal to tonal features from one or more reference audio pieces; and
an interface for providing a list of audio pieces to a user or process.

25. The music processing system of claim 24, wherein the tonality analysis module is configured to extract one or more additional descriptors from the audio signal.

26. The music processing system of claim 25, wherein the one or more additional descriptors includes a dissonance descriptor.

27. The music processing system of claim 25, wherein the one or more additional descriptors includes a rhythmic descriptor.

28. The music processing system of claim 25, wherein the one or more additional descriptors includes a spatial descriptor.

29. The music processing system of claim 24, wherein the tonality comparison device is configured to determine whether the audio piece is a cover version of at least one of the reference audio pieces.
